(19) United States
(12) Patent Application Publication
(10) Pub. No.: US 2002/0175983 A1
(43) Pub. Date: Nov. 28, 2002

(54) Ink composition for inkjet recording

(76) Inventors: Shunichi Ishikawa, Kanagawa (JP); Takayasu Yamazaki, Kanagawa (JP); Masaki Noro, Kanagawa (JP); Yoshiharu Yabuki, Kanagawa (JP)

Correspondence Address: Planton N. Mandros, BURNS, DOANE, SWECKER & MATHIS, L.L.P., P.O. Box 1404, Alexandria, VA, 22313-1404, US

(21) Appl. No.: 09/939,603

(22) Filed: Aug. 28, 2001

(30) Foreign Application Priority Data
Aug. 28, 2000 (JP) P. 2000-257799

(51) Int. Cl. G01D 11/00

(52) U.S. Cl. 347/100

(57) ABSTRACT

An aqueous ink composition for inkjet recording comprising a dye J-aggregate having an average particle size of 2 to 200 nm, and water-dispersible polymer particles having an average particle size of 10 to 400 nm, wherein the amount of the water-dispersible polymer particles is from one to ten times as much as that of the J-aggregate.

### FIELD OF THE INVENTION

The present invention relates to ink compositions for inkjet recording.

### BACKGROUND OF THE INVENTION

Inkjet recording has rapidly prevailed and is now still expanding its applications with various advantages such as economical consumables, high recording speed, low recording noise and an ease of full-color recording. Inkjet recording processes include one ejecting ink droplets by applying pressure with piezoelectric elements, one ejecting ink droplets by generating bubbles in the ink by heat, one based on ultra-sonic wave and one sucking and ejecting ink droplets with electrostatic force. And, as the types of inkjet ink, there are aqueous, oil-based and solid (molten type) inks.

Colorants (dyes and pigments) used in inkjet ink are expected to satisfy the following requirements; high density recording capability, desirable color hue, high fastnesses to light, heat, air exposure, water and chemicals, desirable fixing capability on image-receiving materials accompanying least blur, harmlessness, high purity and availability at reasonable cost. Moreover, to achieve superior color reproduction, the colorants are desired to exhibit absorptions with a suitable half-width on image-receiving materials. But, it is extremely difficult to find colorants that satisfy all of those requirements at sufficiently high levels. Particularly, preferable magenta and cyan colorants satisfying those requirements are severely demanded.

A variety of dyes and pigments have been already proposed for use in inkjet and some of them are in practical use. However, colorants that meet all the requirements mentioned above have not been realized yet. Among conventional colorants well known in the arts and imparted with Color Index (C. I.) numbers, it is almost impossible to satisfy both of the hue and the fastness requirements for inkjet ink. Even when a certain dye exhibiting a desirable hue in the form of ink is used to form an image on an image-receiving material, it tends to develop an undesirable hue with an undesirably large absorption half-width.

Japanese Patent application No. Hei. 11-366571 discloses inkjet inks comprising dyes capable of forming J-aggregates. The J-aggregates set forth therein exhibit vivid colors with narrow absorption half-widths. But the study by the inventors proved that, when inks containing the J-aggregates of such dyes are used for inkjet recording, shorter wavelength absorptions are observed perhaps due to particle coalescence depending on certain types of image-receiving papers, or bronzing phenomena, i.e., metallic luster caused by right reflection at the colorant particle surface is noticeably observed.

On the other hand, as is disclosed, for example, in JP-B-60-32663 (The term “JP-B” as used herein means an “examined Japanese patent application”), it has already been tested to improve the water-resistance, light fastness and rub resistance of inkjet images by adding a fine particulate dispersion (latex) to inkjet inks.

### SUMMARY OF THE INVENTION

The purpose of the invention is to provide inkjet inks that can form preferable images on any type of image-receiving paper, exhibiting desirable hues with narrow half-widths and thus a desirable color reproduction capability.

The problems set forth above has been solved by the following invention.

(1) An aqueous ink composition for inkjet recording comprising a dye J-aggregate having an average particle size of 2 to 200 nm, and water-dispersible polymer particles having an average particle size of 10 to 400 nm, wherein the amount of the water-dispersible polymer particles is from one to ten times as much as that of the J-aggregate.

(2) An image forming method comprising applying an ink composition set forth in (1) above, to an image-receiving material comprising an image-receiving layer and a substrate, wherein the image-receiving layer comprises an inorganic white pigment.

(3) An image forming method comprising applying an ink composition to an image-receiving material, wherein the ink composition comprises a dye J-aggregate, the image-receiving material comprises an image-receiving layer and a substrate, and the image-receiving layer comprises an inorganic white pigment, and uniformly applying water-dispersible polymer particles to the image-receiving material simultaneously with or subsequently to the application of the ink composition.

(4) An image forming method comprising uniformly applying water-dispersible polymer particles to an image-receiving material, the image-receiving material comprising an image-receiving layer and a substrate, wherein the image-receiving layer comprises an inorganic white pigment, and applying an ink composition comprising a dye J-aggregate to the applied water-dispersible polymer particles during the state that the ink composition can pass through the polymer particles to reach the image-receiving material.

(5) The aqueous ink composition set forth in (1) above, wherein the dye J-aggregate has an average particle size of 5 to 100 nm and the water-dispersible polymer particles have an average particle size of 20 to 200 nm.

(6) The aqueous ink composition set forth in (1) above, which has a pH between 4.5 and 10.0.

(7) The aqueous ink composition set forth in (1) above, which has a surface tension of 20 to 60 mN/m.

(8) The aqueous ink composition set forth in (1) above, which has a viscosity not higher than 30 mPa·s.

(9) The aqueous ink composition set forth in (1) above, wherein the water-dispersible polymer particles are a polymer latex.

(10) The aqueous ink composition set forth in (1) above, wherein the water-dispersible polymer particles are water-insoluble polymers each having at least one dissociable group.

(11) The aqueous ink composition set forth in (1) above, wherein the dye for forming the J-aggregate is selected from the groups represented by the following formulae:

A¹═L¹—(L²═L³)ₘ—Q¹ General formula (1)

A¹═L¹—(L²═L³)ₙ—A² General formula (2)

A³═N—Q¹ General formula (3)

A¹═(L¹—L²)ₚ═B¹ General formula (4)

B¹═L¹—(L²═L³)_{q}—B² General formula (5)

B²—(L¹═L²)ᵣ—Q¹ General formula (6)

(Q¹)₃C⁺. (Z^{y-})_{1/y} General formula (7)

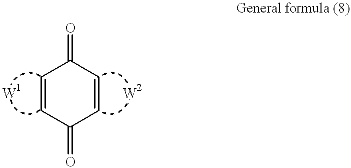

Q¹—N═N—Q² General formula (9)

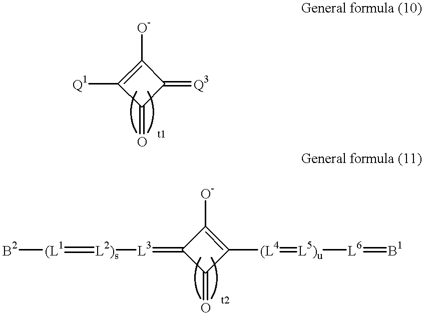

Wherein, A¹ and A²each represents an acid nucleus, A³ represents substituted or unsubstituted phenol, substituted or unsubstituted naphthol, or an acid nucleus, B¹ represents a base nucleus, B²represents the onium form of a base nucleus, Q¹ and Q² each independently represents an aryl group or a heterocyclic group, Q³ represents the onium form of an aryl group or a heterocyclic ring, L¹, L², L³, L⁴, L⁵ and L⁶ each represents a methine group, m, s and u represents an integer of 0, 1 or 2, n and p each represent an integer between 0 and 3, q represents an integer between 0 and 4, r, t₁ and t₂ each represents an integer of 1 or 2, X^{y-} represents an anion, y represents an integer of 1 or 2, and W¹ and W² each independently represents an atomic group needed to complete a five- or six-membered carbocyclic or heterocyclic group.

(12) The image forming method set forth in (2) above, wherein the inorganic white pigment is a synthetic amorphous silica.

### DETAILED DESCRIPTION OF THE INVENTION

The dyes used in the inks for inkjet recording of the invention are those capable of forming J-aggregates whereby the λmax (the wavelength of the peak absorption) shifts at least 20 nm toward the longer wavelength side from the λmax of the molecularly dispersed state achieved in solutions (the solvent being, for example, dimethylformamide or dimethylsulfoxide) As for the details of the J-aggregates of dyes, refer to pp. 216 to 222 of The Theory of the Photographic Process authored by T. H. James.

Although any dye capable of forming a J-aggregate can be used for the present purpose, those which change the λmax in 20 to 150 nm between the molecular dispersion state and the J-aggregated state are preferred, and more preferably those showing 30 to 120 nm shift should be used from the viewpoints of color hue and color reproduction capability. One can select appropriate dyes by taking into account spectral absorption characteristics. Suitable dyes include those represented by the following general formulae (1) to (11), and described in, for example, Senryo Binran (Dyestuff Handbook), edited by the Society of Synthetic Organic Chemistry, Japan and published by Maruzen in 1978, Shikizai (Coloring Agent), 61[4], pp. 215 to 226 (1988), and Kagaku Kogyo (Chemical Industry), pp. 43 to 53 (1986 May).

A¹═L¹—(L²═L³)ₘ—Q¹ General formula (1)

A¹═L¹—(L²═L³)ₙ—A² General formula (2)

A³═N—Q¹ General formula (3)

A¹═(L¹—L²)ₚ═B¹ General formula (4)

B¹═L¹—(L²═L³)_{q}—B² General formula (5)

B²—(L¹═L²)ᵣ—Q¹ General formula (6)

(Q¹)₃C⁺. (Z^{y-})_{1/y} General formula (7)

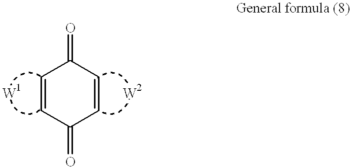

Q¹—N═N—Q² General formula (9)

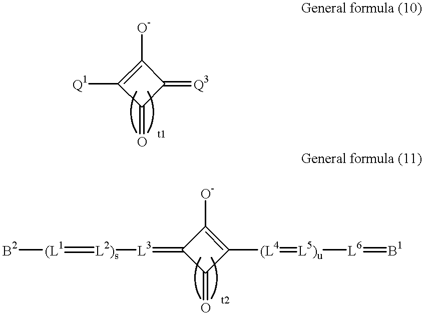

In the above general formulae (1) to (11), A¹ and A² each represents an acid nucleus, A³ represents substituted or unsubstituted phenol, substituted or unsubstituted naphthol, or an acid nucleus, B¹ represents a base nucleus, B² represents the onium form of a base nucleus, Q¹ and Q² each independently represents an aryl group or a heterocyclic group, Q³ represents the onium form of an aryl group or a heterocyclic ring, L¹, L², L³, L⁴, L⁵, and L⁶ each represents a methine group, m, s and u represents an integer of 0, 1 or 2, n and p each represent an integer between 0 and 3, q represents an integer between 0 and 4, r, t₁ and t₂ each represents an integer of 1 or 2. Further, X^{y-} represents an anion, y being an integer of 1 or 2, and W¹ and W² each independently represents an atomic group needed to complete a five- or six-membered carbocyclic or heterocyclic group.

Preferable acid nuclei represented by A¹, A² or A³ include those derived from cyclic ketomethylene compounds, or those derived from such compounds as having a methylene group interposed between two elecron-attracting groups. The cyclic ketomethylene compounds mentioned above include 2-pyrazoline-5-one, rhodanine, hydantoin, thiohydantoin, 2,4-oxazolidinedione, isoxazolone, barbituric acid, thiobarbituric acid, indanedione, dioxopyrazolopyridine, hydroxypyridine, pyrazolidinedione, 2,5-dihydrofuran-2-one and pyrroline-2-one. These cyclic ketomethylene compounds may have a substituent.

Compounds having a methylene group interposed between two elecron-attracting groups can be expressed as Z¹—CH₂—Z² wherein Z¹ and Z² each preferably represents —CN, —SO₂R¹, —COR¹, —COOR², —CONHR², —SO₂NHR² or —C[═C(CN)²]NHR¹. Here, R¹ preferably represents an alkyl or aryl group or a heterocyclic group, and R² preferably represents hydrogen, an alkyl or aryl group or a heterocyclic group. The alkyl, aryl or heterocyclic group represented by R¹ or R² may have a substituent.

Preferable base nuclei represented by B¹ include pyridine, quinoline, indolenine, oxazole, imidazole, thiazole, benzoxazole, benzimidazole, benzothiazole, oxazoline, naphthoxazole and pyrrole, each of which may be substituted. B represents the onium form of a base nucleus that may have a substituent. Especially, the onium form of the base nucleus mentioned as the preferable examples for B¹ are suited.

The aryl group represented by Q¹ or Q² include those substituted or unsubstituted. Phenyl or naphthyl is preferable as the aryl group. The aryl group represented by Q¹ preferably has a dialkylamino group, hydroxy group or an alkoxy group as a substituent. The aryl group represented by Q² preferably has an electron-attracting group such as nitro, cyano, sulfonyl or halogen as a substituent. The heterocyclic group represented by Q¹ or Q² includes substituted and unsubstituted ones. More specifically, suitable heterocyclic groups are pyrrole, indole, furan, thiophene, imidazole, pyrazole, indolizine, quinoline, carbazole, phenothiazine, indoline, thiazole, pyridine, pyridazine, thiadiazine, pyran, thiopyran, oxadiazole, benzoquinoline, thiadiazole, pyrrolothiazole, pyrrolopyridazine, tetrazole, oxazole, cumarine and cumarone.

Examples of the onium form of an aryl or a heterocyclic group represented by Q³ include an aryl group such as phenyl or naphthyl, and the onium forms comprising a heterocyclic ring chosen from those represented by Q¹ and Q² substituted with an onium group such as quaternary ammonium group. Further, heterocyclic onium compounds in which the hetero atom composing the heterocyclic ring takes the cationic form. Each of the aryl and heterocyclic groups enumerated above may have a substituent.

Examples of such substituents include hydrogen, hydroxy group, a halogen atom (e.g., chlorine, bromine, fluorine and iodine), cyano, nitro, carboxyl, sulfo, a straight-chain or cyclic alkyl group of C₁ to C₈ (e.g., methyl, ethyl, isopropyl, n-butyl, n-hexyl, cyclopropylm cyclohexyl, 2-hydoxyethyl, 4-carboxybutyl, 2-methoxyethyl and 2-diethylaminoethyl), an alkenyl group of C₂ to C₈ (e.g., vinyl, allyl and 2-hexenyl), an alkynyl group of C₂ to C₈ (e.g., ethynyl, 1-butynyl and 3-hexynyl), an aralkyl group of C₇ to C₁₂ (e.g., benzyl and phenethyl), an aryl group of C₆ to C₁₀ (e.g., phenyl, naphthyl, 4-carboxyphenyl, 4-acetamidophenyl, 3-methanesulfonamidophenyl, 4-methoxyphenyl, 3-carboxyphenyl, 3,5-dicarboxyphenyl, 4-methansulfoneamidophenyl and 4-butanesulfoneamidophenyl), an acyl group of C₁ to C₁₀ (e.g., acetyl, benzoyl, propanoyl and butnoyl), an alkoxycarbonyl group of C₂ to C₁₀ (e.g., methoxycarbonyl and ethoxycarbonyl), an aryloxycarbonyl group of C₇ to C₁₂ (e.g., phenoxycarbonyl and naphthoxycarbonyl), a carbamoyl group of C₁ to C₁₀ (e.g., unsubstituted carbamoyl, methylcarbaoyl, diethylcarbamoyl and phenylcarbamoyl), an alkoxy group of C₁ to C₈ (e.g., methoxy, ethoxy, butoxy and methoxyethoxy), an aryloxy group of C₆ to C₁₂ (e.g., phenoxy, 4-carboxyphenoxy, 3-methylphenoxy and p-naphthoxy), an acyloxy group of C₂ to C₁₂ (e.g., acetoxy and benzoyloxy), a sulfonyloxy group of C₂ to C₁₂ (e.g., methylsulfonyloxy and phenylsulfonyloxy), an amino group of Co to C₁₀ (e.g., unsubstituted amino, dimethylamino, diethylamino and 2-carboxyethylamino), an acylamino group of C₁ to C₁₀ (e.g., acetamide and benzamide), a sulfonylamino group of C₁ to C₈ (e.g., methylsulfonylamino, phenylsulfonylamino, butylsulfonylamino and n-octylsulfonyamino), an ureido group of C₁ to C₁₀ (e.g., ureido and methylureido), an urethane group of C₂ to C₁₀ (e.g., methoxycarbonylamino and ethoxycarbonylamino), an alkylthio group of C₁ to C₁₂ (e.g., methylthio, ethylthio and octylthio), an arylthio group of C₆ to C₁₂ (e.g., phenylthio and naphthylthio), an alkylsulfonyl group of C₁ to C₈ (e.g., methylsulfonyl and butylsulfonyl), an arylsulfonyl group of C₇ to C₁₂ (e.g., phenylsulfonyl and 2-naphthylsulfonyl), a sulfamoyl group of C₀ to C₈ (e.g., unsubstituted sulfamoyl and methylsulfamoyl) and a heterocyclic group (e.g., 4-pyridyl, piperidino, 2-furyl, furfuryl, 2-thienyl, 2-pyrrolyl and 2-quinolylmorpholino).

The methine group represented by L¹, L², L³, L⁴, L⁵ or L⁶ includes substituted and unsubstituted ones. Further, the substituents of methine groups may bind together to form a four-, five-, six- or seven-membered ring (e.g., cyclobutene, cyclopentene, cyclohexene or cycloheptene).

The anion expressed as X^{y-} represents one that can provide the negative charge needed to neutralize the positive charge of the cation present in a compound represented by the general formula (7). As y represents an integer of 1 or 2, X should preferably be a mono-or di-valent anion. Specific examples for X^{y-} include halogen ions such as Cl⁻, Br⁻ or I⁻, SO₄²⁻, HSO₄⁻ alkylsulfonate ions such as CH₃OSO₃⁻, sulfonic acid ions such asp-toluenesulfonic acid ion, naphthalene-1,5-disulfonic acid ion, methanesulfonic acid ion, trifluoromethanesulfonic acid ion or octanesulfonic acid ion, carboxylic acid ions such as acetate ion, p-chlorobenzoic acid ion, trifluoroacetic acid ion, oxalic acid ion or succinic acid ion, PF₆⁻, BF₄⁻, ClO₄⁻, IO₄⁻, heteropolyacid ions such as tungstic acid ion or tungstophosphoric acid ion, H₂PO₄⁻, NO₃⁻ and phenolate ions such as picric acid ion.

W¹ and W² each represents independently an atomic group necessary to complete a five- or six-membered carbocyclic or heterocyclic group.

There is no restriction on the kind of the substituent which each group described above can have, and specifically, those cited hereinabove are included. Further, two of such substituents may bind together or a substituent may be bonded to either of A¹, A², A³, B¹, B², Q¹, Q², Q³, L¹, L², L³, L⁴, L⁵ or L⁶ to complete a ring structure.

Among the dyes represented by the general formulae (1) to (11) above, those represented by the general formulae (1), (2), (4), (5) and (6) above are preferred because they can stably form J-aggregates. And the dyes represented by the general formulae (2) and (5) are still more preferred. And particularly preferred dyes are those represented by the general formula (2).

As is described in p. 216 to p. 222 of The Theory of the Photographic Process by H. J. James, the cyanine dyes represented by the general formula (5) can form J-aggregates, and are thus suited for the colorant of the inkjet ink of the invention. Among the oxonole dyes represented by the general formula (2), those described in JP-A-9-179246 (The term “JP-A” as used herein means an “unexamined published Japanese patent application”)), European Patent No. 778493, U.S. Pat. Nos. 5,922,593, 5,928,849and 5,965,333 are preferably used as the colorant of the inkjet ink of the invention, because they can form aggregates that bathochromically shift the absorption peak as are pointed out in these references.

The dyes represented by one of the above-described general formulae (1) to (11) can be synthesized by the methods described in the following patent specifications; WO No. 88/04794, EP Nos. 274,723, 276,556and 299,435, U.S. Pat. Nos. 2,527,583, 3,486,897, 3,746,539, 3,933,798, 4,130,429 and 4,040,841, JP-A-48-68623, JP-A-52-92716, JP-A-55-155350, JP-A-55-155351, JP-A-61-205934, JP-A-2-173630, JP-A-2-230135, JP-A-2-277044, JP-A-2-282244, JP-A-3-7931, JP-A-3-167546, JP-A-3-13937, JP-A-3-206443, JP-A-3-208047, JP-A-3-192157, JP-A-3-216645, JP-A-3-274043, JP-A-4-37841, JP-A-4-45436, JP-A-4-138449 and JP-A-5-197077, Japanese Patent Application Nos. Hei. 5-273811, Hei. 6-7761 and Hei. 6-155727.

The dyes can also be prepared by still other methods modified from those cited above.

Some specific examples of dyes used in the ink for inkjet recording of the invention will be shown, to which, however, the scope of the invention is not limited as for the dyes to be used.

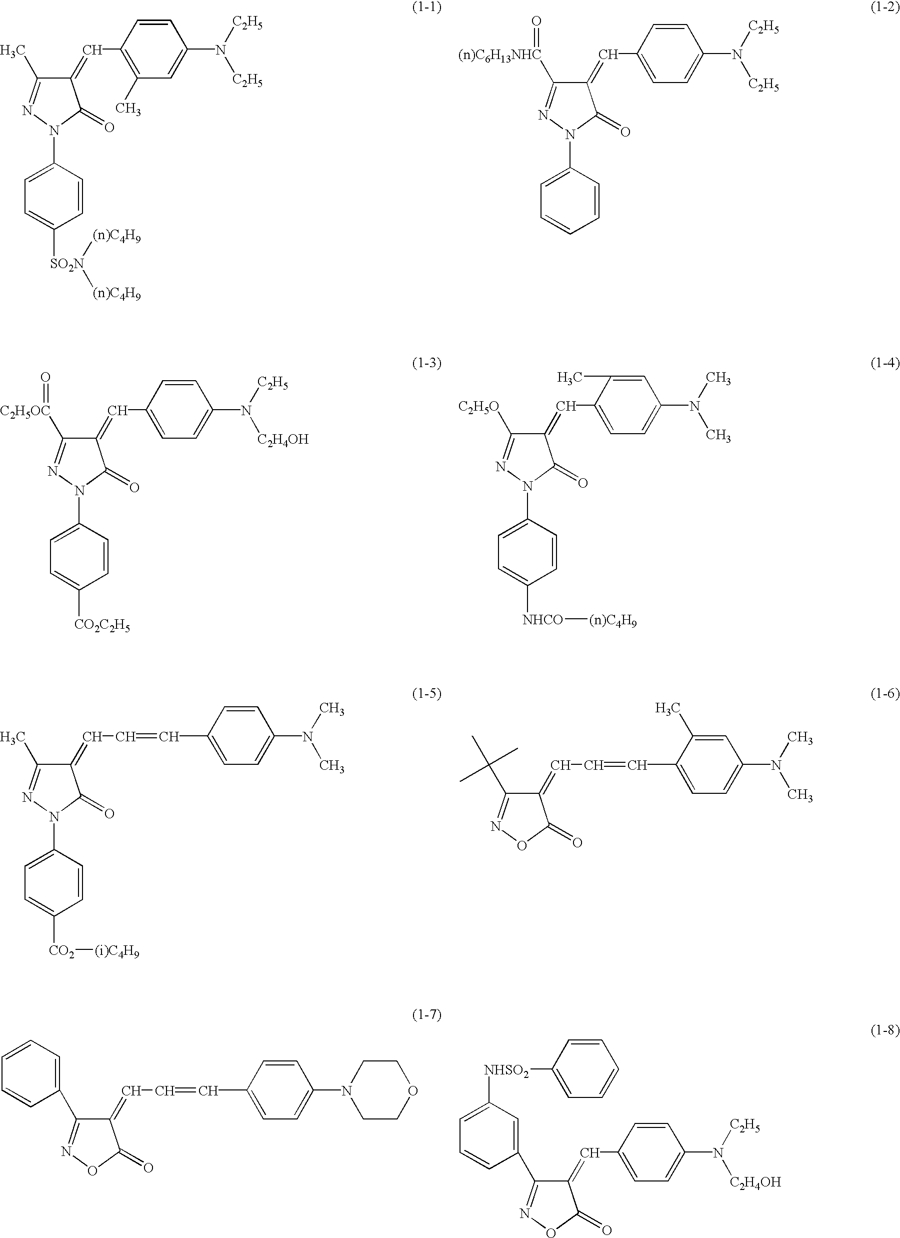

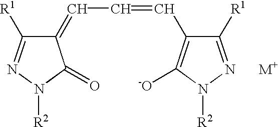

| | R¹ | R² | M⁺ |
|---|---|---|---|
| 2-4 | CH₃— | H₂NCO— | (C₂H₅)₃N⁺H |
| 2-5 | C₂H₅— | H₂NCO— | (C₂H₅)₃N⁺H |
| 2-6 | 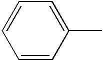 | H₂NCO— | 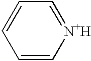 |
| 2-7 | H₂NCO— | CH₃— | H⁺ |
| 2-8 | H₂NCO— | C₂H₅— | H⁺ |
| 2-9 | H₂NCO— | 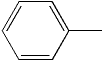 | (C₂H₅)₃N⁺H |
| 2-10 | 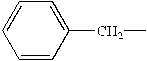 | H— | 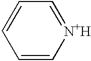 |
| 2-11 | 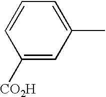 | H— | H⁺ |

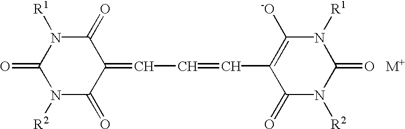

| | R¹ | R² | M⁺ |
|---|---|---|---|
| 2-12 | 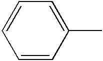 | H— | (C₂H₅)₃N⁺H |
| 2-13 | 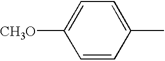 | H— | (C₂H₆)₃N⁺H |
| 2-14 | 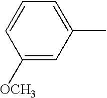 | H— | (C₂H₅)₃N⁺H |
| 2-15 | 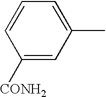 | H— | H⁺ |
| 2-16 | 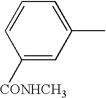 | H— | H⁺ |
| 2-17 | 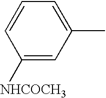 | H— | Na⁺ |
| 2-18 | 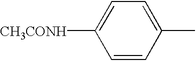 | H— | (C₂H₅)₃N⁺H |
| 2-19 | 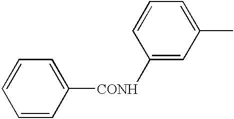 | H— | (C₂H₅)₃N⁺H |

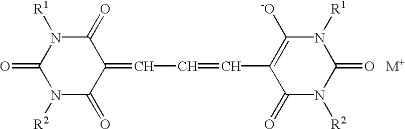

| | R¹ | R² | M⁺ |
|---|---|---|---|
| 2-20 | 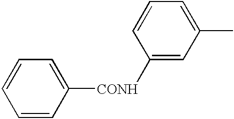 | H— | H⁺ |
| 2-21 | 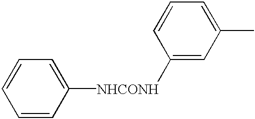 | H— | 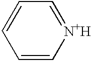 |
| 2-22 | 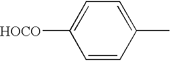 | H— | H⁺ |
| 2-23 | 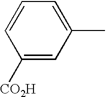 | H— | H⁺ |
| 2-24 | 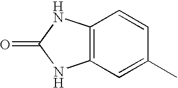 | H— | (C₂H₅)₃N⁺H |
| 2-25 | 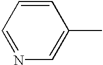 | H— | H⁺ |
| 2-26 | H₂COCH₂CH₂— | H— | H⁺ |
| 2-27 | H₂NCOCH₂— | H— | H⁺ |
| 2-28 | H₂NCOCH₂CH₂— | H₂NCOCH₂CH₂— | H⁺ |

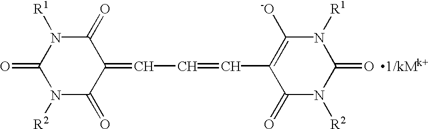

| | R¹ | R² | M^{k+} |
|---|---|---|---|
| 2-20a | 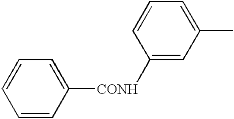 | H⁻ | Ca^{20 +} |
| 2-20b | 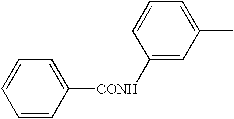 | H⁻ | Al³⁺ |
| 2-20c | 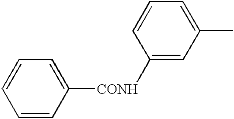 | H⁻ | 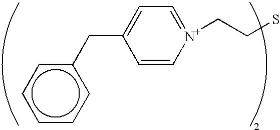 |
| 2-20d | 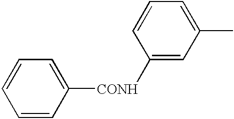 | H⁻ | 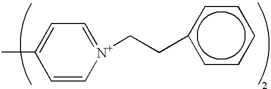 |

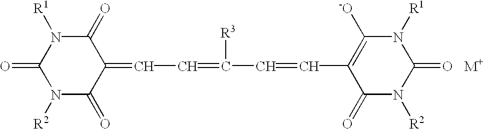

| | R¹ | R² | R³ | M⁺ |
|---|---|---|---|---|
| 2-29 | 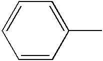 | H— | —CH₃ | H⁺ |
| 2-30 | 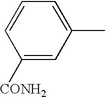 | H— | —H | (C₂H₃)₃N⁺H |
| 2-31 | 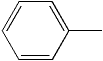 | H— | 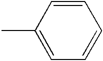 | H⁺ |

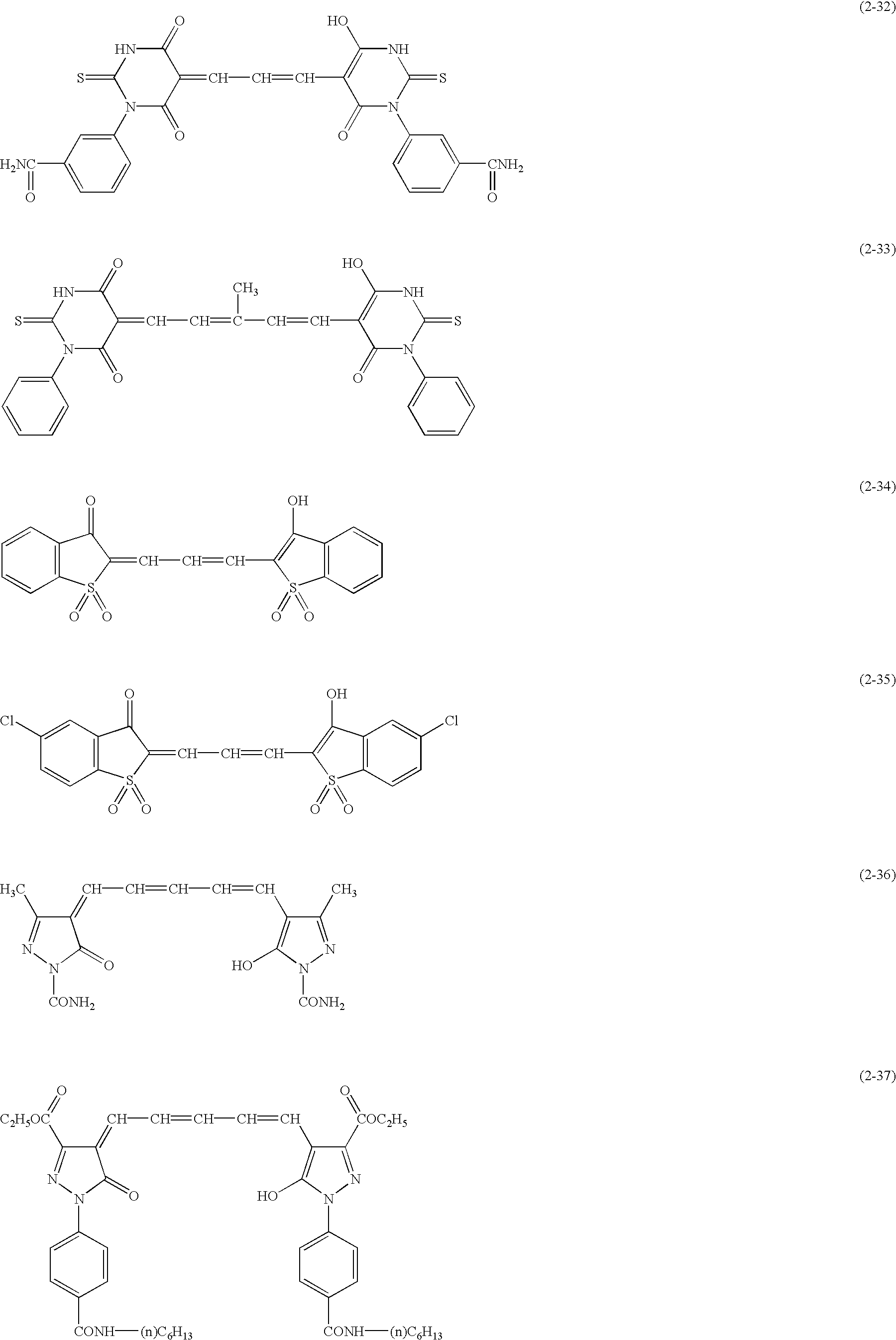

Ink compositions for inkjet recording of the invention can be prepared by first forming the J-aggregate of a dye, and then by dispersing the J-aggregate into an aqueous medium. Alternatively, a particulate J-aggregate can be formed in an aqueous medium by slowly dissolving a dye into the medium that contains a compound causing J-aggregation. In either case, it is desirable to obtain a finely divided J-aggregate with use of a dispersing device such as ball mill, sand mill, attritor, roll mill, agitator mill, Henschel mixer, colloid mill, ultrasonic homogenizer, pearl mill, jet mill or ong mill. In the two preparation processes cited above, the latter one comprising slowly dissolving dyes in an aqueous medium that contains a compound causing J-aggregation is preferred because it requires a less dispersing energy than the former process.

In order to accelerate J-aggregation of a dye, it is desirable to raise the dielectric constant of the aqueous medium, as is described in p. 220 of The Theory of the Photographic Process by T. H. James. Typically, the dielectric constant of the aqueous medium can be raised by increasing the water content, or by adding an electrically charged compound or salt as aggregation accelerator. Typical examples of aggregation accelerator include sodium hydroxide, potassium hydroxide, inorganic metal salts (e.g., sodium chloride or potassium chloride), organic onium salts (e.g., quaternary ammonium salts), organic onium group-containing polymers, acid group-containing polymers and gelatin. As is described in JP-A-4-141494, there are cases in which a polymer salt charged in the polarity opposite to that of the dye acts to accelerate J-aggregation. Such polymer salts include sodium polyacrylate and poly(vinylsulfuric acid).

J-aggregates with average particle sizes below 2 nm cannot exhibit the favorable characteristics as particles such as fastnesses to heat, light and chemicals. On the other hand, those with average particle sizes exceeding 200 nm tend to show poor dispersion stability. Thus, the preferable range for the average particle size of the J-aggregate is 2 to 200 nm, more preferably 5 to 100 nm.

Next, water-dispersible polymer particles will be described as an essential component in the invention.

When inkjet recording is performed by using an aqueous ink containing water-dispersible polymer particles together with the dye J-aggregate, the aqueous medium and water soluble ingredients penetrate into the paper substrate, causing the J-aggregate and the water-dispersible polymer particles to coexist near the surface of the image-receiving paper. By appropriate selection of the particle size and the amount of the water-dispersible polymer particles, it has been found that bronzing-free images with vivid colors result. Particularly, the recording method of the invention proved to exhibit a surprisingly favorable effect with high quality type image-receiving layers comprising ultra-fine particles of silica or alumina that are aggregated to form very fine, 10 to 30 nm diameter pores. In contrast, when inkjet recording is performed on high quality type image-receiving materials described above with an ink containing dye aggregates but free of water-dispersible polymers, noticeable bronzing accompanying strong metallic luster was observed due to the fact that the J-aggregates are oriented in a pure form at the surface of the image-receiving layer. Such bronzing disappears with inks containing water-dispersible polymers, thus giving rise to vivid color images. The mechanism of such a desirable effect of the polymers, though not perfectly elucidated, may presumably be that the polymer acts to prevent the coalescence of the J-aggregate particles on the image-receiving paper and further cover the surface of the J-aggregate particles.

The water-dispersible polymer particles may stay in the form of particle or form a continuous film after image recording, but to secure the surface gloss, the water- and rub-resistance of the recorded images, the polymer particles should preferably form a film; in the case where the polymer particles are not converted to a film at room temperature after recording, the print may be subjected to a suitable treatment such as heating.

Image formation by inkjet recording can be performed by the use of two ink compositions, one containing water-dispersible polymer particles and the other containing a J-aggregate of a dye. These two compositions are separately applied onto an image-receiving paper. In such a recording, simultaneously with or subsequently to the imagewise application of the J-aggregate-containing composition onto an image-receiving paper, the polymer-containing composition may be uniformly applied. Alternatively, after the water-dispersible polymer particles are uniformly applied onto an image-receiving paper, then an ink composition containing a J-aggregate of a dye may be applied imagewise. In the latter case where the water-dispersible polymer particles are applied beforehand, however, the J-aggregate-containing ink composition must be applied while the polymer particles present near the surface of the image-receiving paper are in such a state that the ink composition can pass through the polymer particles to penetrate into the image-receiving layer or the paper substrate.

Examples of the water-dispersible polymer particles used in the invention include those known as polymer latex (fine polymer dispersion). A polymer latex, which is usually prepared by emulsion polymerization using vinyl monomers, comprises a polymer finely dispersed in an aqueous medium.

The structure of the polymer composing a polymer latex may be a homopolymer of a monomer or a copolymer comprising an arbitrary combination of monomers chosen from the group enumerated below as representative examples of preferable monomers. Any monomer unit can be used for the invention without any special limitation provided that it can be polymerized by radical polymerization.

Groups of monomer

(a) Olefins: ethylene, propylene, isoprene, butadiene, vinyl chloride, vinylidene chloride, 6-hydroxy-1-hexene, cyclopentadiene, 4-pentenoic acid, methyl 8-nonenoate, vinylsulfonic acid, trimethylvinylsilane, trimethoxyvinylsilane, pentadiene, 1,4-divinylcyclohexane, and 1,2,5-trivinylcyclohexane.

(b) α,β-unsaturated carboxylic acids and salts thereof: acrylic acid, methacrylic acid, itaconic acid, maleic acid, sodium acrylate, ammonium methacrylate, and potassium itaconate.

(c) Derivatives of α,β-unsaturatedcarboxylic acid: alkyl acrylates (e.g., methyl acrylate, ethyl acrylate, n-butyl acrylate, cyclohexyl acrylate, 2-ethylhexyl acrylate and n-dodecyl acrylate), substituted alkyl acrylates (e.g., 2-chloroethylacrylate, benzylacrylate, 2-cyanoethylacrylate and allyl acrylate), alkyl methacrylates (e.g., methyl methacrylate, n-butylmethacrylate, 2-ethylhexylmethacrylate and n-dodecyl methacrylate), substituted alkyl methacrylates (e.g., 2-hydroxyethyl methacrylate, glycidyl methacrylate, glycerin monomethacrylate, 2-acetoxyethyl methacrylate, tetrahydrofurfurylmethacrylate, 2-methoxyethylmethacrylate, ω-methoxypoly(ethylene glycol) methacrylate with 2 to 100 moles of added polyoxyethylene, poly(ethylene glycol) monomethacrylate with 2 to 100 moles of added polyoxyethylene, polypropylene glycol) monomethacrylate with 2 to 100 moles of added polyoxyethylene, 2-carboxyethyl methacrylate, 3-sulfopropyl methacrylate, 4-oxysulfobutyl methacrylate, 3-trimethoxysilylpropyl methacrylate and allyl methacrylate), derivatives of unsaturated dicarboxylic acids (e.g., monobutyl maleate, dimethyl maleate, monomethyl itaconate and dibutyl itaconate), polyfunctinal esters (e.g., ethylene glycol diacrylate, ethylene glycol dimethacrylate, 1,4-cyclohexane diacrylate, pentaerythritol tetramethacrylate, pentaerythritol triacrylate, trimethylolpropane triacrylate, trimethylolethane triacrylate, dipentaerythritol pentamethacrylate, pentaerythritol hexaacrylate, and 1,2,4-cyclohexane tetramethacrylate).

(d) Amides of α,β-unsaturated carboxylic acids: acrylamide, methacrylamide, N-methylacrylamide, N,N-dimethylacrylamide, N-methyl-N-hydroxyethylacrylamide, N-tert-butylacrylamide, N-tert-octylacrylamide, N-cyclohexylacrylamide, N-phenylacrylamide, N-(2-acetoacetoxyethyl)acrylamide, N-acryloylmorpholine, diacetoneacrylamide, itaconic acid diamide, N-methylmaleimide, 2-acrylamide-2-methylpropanesulfonic acid, methylene-bis-acrylamide, and dimethacryloylpyperadine.

(e) Styrene and its derivatives: styrene, vinyltoluene, p-tert-butylstyrene, vinylbenzoic acid, methyl vinylbenzoate, a-methylstyrene, p-chloromethylstyrene, vinylnaphthalene, p-hydroxymethylstyrene, sodium p-styrenesulfoneate, potassium p-styrenesulfinate, 1.4-divinylbenzene, 4-vinylbenzoic acid-2-acryloylethyl ester and the like.

(f) Vinyl ethers: methyl vinyl ether, butyl vinyl ether, and methoxyethyl vinyl ether.

(g) Vinyl esters: vinyl acetate, vinyl propionate, vinyl benzoate, vinyl salicylate, vinyl chloroacetate and the like.

(h) Other polymerizable monomers: N-vinylpyrrolidone, 2-vinyloxazoline, 2-isopropenyloxazoline, and divinylsulfone.

Among latices prepared by copolymerization of various combinations of these monomers, those mainly comprising an acrylate or a methacrylate resin, a styrene resin, a conjugated diene resin, vinyl acetate resin or polyolefin resin in the form of homo- or co-polymer are preferred. Particularly, polymers containing ethylenically unsaturated groups in their main or side chains are preferred. In other words, polymers comprising at least one monomer having a conjugated diene group or at least two unconjugated ethylenically unsaturated groups in which each unsaturated group differs in polymerization reactivity from each other are preferred. In particular, those containing conjugated diene groups are preferred.

Monomers satisfying the above-described conditions, that is, having at least two unconjugated ethylenically unsaturated groups in which each unsaturated group differs in polymerization reactivity from each other include allyl acrylate, allyl methacrylate, N-allylacrylamide and N-allyl methacrylate. And, particularly preferable conjugated diene monomers include 1,3-butadiene, isoprene, 1,3-pentadiene, 2-ethyl-1,3-butadiene, 2-n-propyl-1,3-butadiene, 2,3-dimethyl-1,3-butadiene, 2-methyl-1,3-pentadiene, 1-phenyl-1,3-butadiene, 1-α-naphthyl-1,3-butadiene, 1-βA-naphthyl-1,3-butadiene, 2-chloro-1,3-butadiene, 2-bromo-1,3-butadiene, 1-chlorobutadiene, 2-fluoro-1,3-butadiene, 2,3-dichloro-1,3-butadiene, 1,1,2-trichloro-1,3-butadiene, 2-cyano-1,3-butadiene, 1,4-hexadiene, cyclopentadiene and ethylydenenorbornene.

Table 1 lists some examples of the polymer latex preferably used in the invention, but the invention is not construed as limited to these examples. The numerals in the table indicating the monomer composition are in terms of weight percentage, if not specifically mentioned.

TABLE 1

| | |
|---|---|
| P-1 | styrene/butadiene (80/20) |
| P-2 | styrene/butadiene/acrylic acid (70/27/3) |
| P-3 | styrene/butadiene/acrylic acid(48/49/3) |
| P-4 | styrene/butadiene (37/63) |
| P-5 | styrene/butadiene (23/77) |
| P-6 | butadiene (homopolymer) |
| P-7 | isoprene (homopolymer) |
| P-8 | ethyl acrylate/butadiene (40/60) |
| P-9 | ethyl acrylate/styrene/butadiene (40/30/30) |
| P-10 | isoprene/styrene/vinyltoluene (50/25/25) |
| P-11 | methyl acrylate (homopolymer) |
| P-12 | ethyl acrylate (homopolymer) |
| P-13 | ethyl acrylate/methyl methacrylate (70/30) |
| P-14 | ethyl acrylate/styrene/Na |
| | 2-acrylamide-2-methylpropanesulfonate (55/40/5) |
| P-15 | n-butyl acrylate/styrene (40/60) |
| P-16 | n-butyl acrylate/t-butyl acrylate/acrylic acid |
| | (47/50/3) |
| P-17 | 2-ethylhexyl acrylate/styrene (50/50) |
| P-18 | n-butyl metyacrylate (homopolymer) |
| P-19 | n-butyl methacrylate/methacrylic acid(90/10) |
| P-20 | n-butyl methacrylate/methoxy poly(ethylene glycol) |
| | (n = 9) monomethacrylate (80/20) |
| P-21 | 2-ethylhexyl methacrylate/styrene/2-hydroxythyl |
| | methacrylate/acrylic acid (40/40/18/2) |
| P-22 | n-dodecyl methacrylate/methyl methacrylate/styrene/ |
| | Na styrenesulfonate (45/25/25/5) |
| P-23 | benzyl methacrylate/methyl acrylate (80/20) |
| P-24 | styrene/n-butyl acrylate/allyl methacrylate |
| | (40/30/30) |
| P-25 | 2-ethylhexyl methacrylate/styrene/allyl |
| | methacrylate/methacrylic acid (30/35/30/5) |
| P-26 | vinyl acetate (homopolymer) |
| P-27 | t-butylacrylamide/n-butyl acrylate/2-carboxyethyl |
| | acrylate (45/45/10) |
| P-28 | methyl acrylate/2-acetoacetoxyethyl methacrylate/ |
| | acrylic acid (80/17/3) |
| P-29 | ethylene glycol dimethacrylate/n-butyl methacrylate/ |
| | acrylic acid (5/92/3) |
| P-30 | ethylene glycol dimethacrylate/styrene/n-butyl |
| | acrylate (10/45/45) |
| P-31 | ethylene glycol dimethacrylate/ethyl methacrylate/ |
| | glycidyl methacrylate/methoxy poly(ethylene glycol |
| | (n = 23) monomethacrylate (5/60/20/15) |
| P-32 | divinylbenzene/styrene/2-ethylhexyl methacrylate |
| | (5/45/50) |
| P-33 | trivinylcyclohexane/n-butyl methacrylate/ |
| | 2-carboxyethyl acrylate (5/75/20) |

These polymer latices may be used individually or in combination of two or more kinds if necessary.

Polymer latices synthesized by emulsion polymerization generally have large molecular weights of more than 100,000 in weight-averaged value, compared to those by solution polymerization if no chain transfer agent is used. In cases where conjugated diene monomers or monomers having at least two ethylenically unsaturated groups are used, the molecular weight may become substantially infinite due to crosslinking reaction.

Descriptions of emulsion polymerization adopted to synthesize polymer latices will follow. In emulsion polymerization, monomers are emulsified in an aqueous medium in 5 to 150% by weight of the amount of the medium with the aid of at least one kind of emulsifier used at an amount of 0.1 to 20% by weight of the monomer amount. The medium consists of water or mixtures comprising water and water-miscible organic solvents (e.g., methanol, ethanol or acetone. With the addition of a radical polymerization initiator of 0.02 to 5% by weight of the monomer amount, the emulsified mixture is heated to 30 to 100° C., preferably 40 to 90° C. under stirring. The amount of the water-miscible organic solvent should be 0 to 100% by volume, preferably 0 to 50% by volume.

Polymerization initiators include azobis compounds, peroxides, hydroperoxides and redox catalysts, exemplified by inorganic peroxides (e.g., potassium persulfate and ammonium persulfate, organic peroxides (e.g., t-butyl peroctoate, benzoyl peroxide, isopropylpercarbonate, 2,4-dichlorobenzoyl peroxide, methyl ethyl ketone peroxide, cumene hydroperoxide and dicumyl peroxide, azo compounds (e.g., 2,2′-azobisisobutylate, sodium salt of 2,2′-azobiscyanovaleric acid, 2,2′-azobis (2-amidinopropane) hydrochloride, 2,2′-azobis[2-(5-methyl-2-imidazoline-2-yl)propane] hydrochloride and 2,2′-azobis{2-methyl-N-[1,1′-bis(hydroxymethyl)-2-hydroxye thyl]propionamide}. Among those compounds, potassium persulfate and ammonium persul fate are particularly preferred.

As the emulsifier, anionic, cationic, amphoteric and nonionic surfactants and water soluble polymers can be used. Specific examples include, for example, sodium laurate, sodium dodecylsulfate, sodium 1-octoxycarbonylmethyl-1-octoxycarbonylmethanesulfonate, sodium laurylnaphthalenesulfonate, sodium laurylbenzenesulfonate, sodium laurylphosphate, cetyltrimethylammonium chloride, N-2-ethylpyridinium chloride, polyoxyethylene nonylphenyl ether, polyoxyethylenesorbitane lauryl ether, poly(vinylalchol), the emulsifiers disclosed in JP-B-53-6190, and water soluble polymers.

It needs not to say that the conditions of emulsion polymerization can be extensively changed as for the kind and quantity of polymerization initiator, reaction temperature and reaction period, depending on the purpose of the resulting product. The emulsion polymerization reaction can be carried out either by introducing a polymerization initiator into a reaction vessel which has been charged with the whole amounts of the monomer, the surfactant and the aqueous medium, or by adding dropwise a partial or total amount of the monomer and/or the initiator solution if necessary. The latices applicable to the invention can be readily prepared by ordinary emulsion polymerization processes well known in the art. Reference can be made on emulsion polymerization to the following books; Gousei Jushi Emarujon (Synthetic Resin Emulsion) edited by Taira Okuda and Hiroshi Inagaki, and published by Kobunshi Kankokai (Polymer Material Publisher) in 1978, Gousei Ratekkusu no Oyo (Applicatins of Synthetic Latices) edited by Taka-aki Sugimura, Yasuo Kataoka, Souichi Suzuki, and Keiji Kasahara, and published by Kobunshi Kankokai in 1993 and Gousei Rattekusu No Kagaku (Chemistry of Synthetic Latices) authored by Souichi Muroi and published by Kobunshi Kankokai (Polymer Material Publisher) in 1970.

Further, latices known as the soap-free type can be favorably applied to the invention.

Other examples for the water-dispersible polymer particles used in the invention are water-insoluble polymers each having at least one dissociable group. Such dissociable group-containing polymers have ionic dissociable groups. As the ionic dissociable groups, cationic ones such as tertiary and quaternary ammonium groups, and anionic ones such as carboxylic, sulfonic and phosphoric acid are included. Examples of the above-cited polymers include vinyl polymers and poly condensation polymers such as polyurethane, polyester, polyamide, polyurea and polycarbonate. These water-insoluble, dissociable group-containing polymers should preferably be provided with water-dispersible property, i. e., self-emulsifying property.

The dissociable groups to be contained in such dissociable group-containing vinyl polymers include anionic ones exemplified by carboxylic group, sulfonic acid group, sulfuric acid monoester group, —OPO(OH)₂, sulfinic acid group and the salts (with alkali metals such as, e.g., Na and K, or with ammnonium compounds such as ammnonia, dimethylamine, ethanolamine, diethanolamine, triethanolamine and trimethylamine) thereof, and cationic ones exemplified by primary, secondary and tertiary amines and the salts (with organic acids such as acetic, propionic and methane sulfonic, or with inorganic acids such as hydrochloric and sulfuric) thereof, and quaternary ammonium salts. Among these groups, anionic ones, particularly carboxylic group, are preferred.

Monomers containing carboxylic acid as the dissociable group include, for example, acids such as acrylic, methacrylic, itaconic, maleic, fumaric, citraconic or crotonic acid, monoalkyl esters of itaconic acid (e.g., monomethyl, monoethyl and monobutyl itaconate), and monoalkyl esters of maleic acid (e.g., monomethyl, monoethyl and monobutyl maleate).

Monomers containing sulfonic acid as the dissociable group include, for example, styrenesulfonic acid, vinylsulfonic acid, acryloyloxyalkylsulfonic acids (e.g., acryloyloxyethylsulfonic or acryloyloxypropylsulfonic acid), methacryloyloxyalkylsulfonic acids (e.g., methacryloyloxyethylsulfonic or methacryloyloxypropylsulfonic acid), acrylamidoalkylsulfonic acids (e.g., 2-acrylamido-2-methylethanesulfonic, 2-acrylamido-2-methylpropanesulfonic or 2-acrylamido-2-methylbutanesulfonic acid), methacrylamidoalkylsulfonic acids (e.g., 2-methacrylamido-2-methylethanesulfonic or 2-methacrylamido-2-methylpropanesulfonic acid).

Monomers containing phosphoric acid as the dissociable group include, for example, phosphoric acid monoacryloyloxyethyl ester and phosphoric acid monomethacyloyloxyethyl ester.

Among the monomers set forth heretofore, preferable ones are acrylic acid, methacrylic acid, styrenesulfonic acid, vinylsulfonic acid, acrylamidoalkylsulfonic acids and methacrylamidoalkylsulfonic acids, while particularly preferable ones are acrylic acid, methacrylic acid, styrenesulfonic acid, 2-acrylamido-2-methylpropanesulfonic acid and 2-acrylamido-2-methylbutanesulfonic acid.

Monomers containing cationic dissociable groups include, for example, those having a tertiary amino group such as dialkylaminoethyl methacrylate and dialkylaminoethyl acrylate, and those having a quaternary ammonium group such as N-2-acryloyloxyethyl-N,N,N-trimethylammonium chloride or N-vinylbenzyl-N,N,N-triethylammonium chloride.

The dissociable group-containing monomers described heretofore can be copolymerized with monomers having no dissociable group. Such monomers to be copolymerized include the following.

Acrylic acid esters: specifically, methyl, ethyl, n-propyl, isopropyl, n-butyl, isobutyl, sec-butyl, tert-butyl, hexyl, 2-ethylhexyl, tert-octyl 2-chloroethyl, 2-bromoethyl, 4-chlorobutyl, 2-acetoxyethyl, benzyl, cyclohexyl, furfuryl, tetrahydrofurfuryl, phenyl, 2-hydroxyethyl, 2,2-dimethyl-3-hydroxypropyl, 2-methoxyethyl, 3-methoxybutyl, 2-ethoxyethyl, 2-butoxyethyl, 2- (2-methoxyethyoxy) ethyl, glycidyl, 1-bromo-2-methoxyethyl, 2,2,2-tetrafluoroethyl or 1H,1H,2H,2H-perfluorodecyl acrylates, diphenyl-2-acryloyloxyethyl phosphate, and dibutyl-2-acryloyloxyethyl phosphate.

Methacrylic acid esters: specifically, methyl, ethyl, n-propyl, isopropyl, n-butyl, isobutyl, sec-butyl, tert-butyl, cyclohexyl, benzyl, 2-ethylhexyl, lauryl, stearyl, furfuryl, tetrahydrofurfuryl, phenyl, cresyl, naphthyl, 2-hydroxyethyl or 4-hydroxybutyl methacrylates, triethylene glycol monomethacrylate, dipropylene glycol monomethacrylate, 2-methoxyethyl, 3-methoxybutyl, 2-ethoxyethyl, 2-butyoxyethyl, 2-(2-methoxyethoxy)ethyl, 2-(2-ethoxyethoxy)ethyl, 2-acetoxyethyl, 2-acetoacetoxyethyl, allyl, glycidyl, 2,2,2-tetrafluoroethyl or 1H,1H,2H,2H-perfluorodecyl methacrylates, dioctyl-2-methacryloyoxyethyl phosphate and the like.

Vinyl esters: specifically, vinyl acetate, vinyl propionate, vinyl butyrate, vinyl caproate, vinyl chloroacetate, vinyl methoxyacetate, vinyl phenylacetate, vinyl benzoate and vinyl salicylate.

Acrylamides: specifically, acrylamide, methylacrylamide, ethylacrylamide, isopropylacrylamide, n-butylacrylamide, tert-butylacrylamide, tert-octylacrylamide, cyclohexylacrylamide, benzylacrylamide, hydroxymethylacrylamide, methoxymethylacrylamide, butoxymethylacrylamide, methoxyethylacrylamide, phenylacrylamide, dimethylacrylamide, diethylacrylamide, β-cyanoethylacrylamide, N-(2-acetoacetoxyethyl)acrylamide, and diacetoneacrylamide.

Methacrylamides: specifically methacrylamide, methylmethacrylamide, ethylmethacrylamide, propylmethacrylamide, n-butylmethacrylamide, tert-butylmethacrylamide cyclohexylmethacrylamide, benzylmethacrylamide, hydroxymethylmethacrylamide, methoxyethylmethacrylamide, phenylmethacrylamidem, β-cyanoethylmethacrylamide, and N-(2-acetoacetoxyethyl)methacrylamide.

Olefins: specifically, dicyclopentadiene, ethylene, propylene, 1-butene, 1-pentene, vinyl chloride, vinylidene chloride, isoprene, chloroprene, butadiene, and 2,3-dimethylbutadiene.

Styrenes: for example, styrene, methylstyrene, dimethylstyrene, trimethylstyrene, ethylstyrene, chloromethylstyrene, methoxystyrene, acetoxystyrene, chlorostyrene, dichlorostyrene, bromostyrene and methyl vinylbenzoate.

Vinyl ethers: specifically methyl vinyl ether, butyl vinyl ether, hexyl vinyl ether, and methoxyethyl vinyl ether.

Other monomers include butyl or hexyl crotonate, dimethyl or dibutyl itaconate, diethyl or dimethyl maleate, diethyl, dimethyl or dibutyl fumarate, methyl vinyl ketone, phenyl vinyl ketone, methoxy ethylvinyl ketone, N-vinyloxazolidone, N-vinylpyrrolidone, vinylidene chloride, methylenemalonitrile and vinylidene.

Further, monomers containing nonionic dispersible groups as will be described below may also be used for copolymerzation. Such monomers include esters comprising a poly(ethylene glycol) monoalkyl ether and a carboxylic acid monomer, esters comprising a poly(ethylene glycol) monoalkyl ether and a sulfonic acid monomer, or esters comprising a poly (ethylene glycol) monoalkyl ether and a phosphoric acid monomer, vinyl group-containing urethanes comprising a poly(ethylene glycol) monoalkyl ether with an isocyanate group-containing monomer, and macro-monomers containing a poly(vinyl alcohol) structure.

The number of the ethylene oxide recurring unit in the poly(ethylene glycol) monoalkyl ethers cited above lies preferably in the range of from 8 to 50, and more preferably from 10 to 30. The carbon number of the alkyl group in the poly(ethylene glycol) monoalkyl ethers cited above lies preferably in the range of from 1 to 20, and more preferably from 1 to 12.

Now, polycondensation polymers containing dissociable groups cited above will be described.

The dissociable group-containing polyurethanes are basically synthesized from a diol compound and a diisocyanate compound.

Practical examples of diol compounds include non-dissociable diols such as ethylene glycol, 1,2-propanediol, 1,3-propanediol, 1,3-butanediol, 2,3-butanediol, 2,2-dimethyl-1,3-propanediol, 1,4-pentanediol, 2,4-pentanediol, 3,3-dimethyl-1,2-butanediol, 2-ethyl-2-methyl-1,3-propanediol, 1,6-hexanediol, 2,5-hexanediol, 2-methyl-2,4-pentanediol, 2,2-diethyl-1,3-propanediol, 2,4-dimethyl-2,4-pentanediol, 2-methyl-2-propyl-1,3-propanediol, 2,5-dimethyl-2,5-hexanediol, 2-ethyl-1,3-hexanediol, 1,2-octanediol, 2,2,4-trimethyl-1,3-pentanediol, 1,4-cyclohexanedimethanol, diethylene glycol, triethylene glycol, dipropyleneglycol, tripropyleneglycol, poly(ethylene glycol) (averagemolecularweight=200 to 4000), poly (propylene glycol) (average molecular weight=200 to 1000), polyester polyol, 4,4′-dihydroxydiphenyl-2,2-propane, and 4,4′-dihydroxyphenylsulfone.

Preferable diisocyanates include ethylenediisocyanate, isophoronediisocyanate, hexamethylenediisocyanate, 1,4-cyclohexanediisocyanate, 2,4-toluenediisocyanate, 1,3-xylylenediisocyanate, 1,5-naphthalenediisocyanate, m-phenylenediisocyanate, p-phenylenediisocyanate, 3,3′-dimethyl-4,4′-diphenylmethanediisocyanate, 3,3′-dimethylbiphenylenediisocyanate, dicyclohexylmethanediisocyanate and methylenebis(4-cyclohexylisocyanate).

Dissociable group-containing polyurethanes can be obtained with use of a dissociable group-containing diol for synthesis. Such dissociable groups can be introduced in the polymer principal chain of the polyurethane as substituents. Diols having a dissociable anionic group include 2,2-bis(hydroxymethyl)propionic acid, 2,2-bis(hydroxymethyl)butanoic acid, 2,5,6-trimethoxy-3,4-dihydroxyhexanoic acid, 2,3-dihydroxy-4,5-dimethoxypentanoic acid, 3,5-di(2-hydroxy)ethyloxycarbonylbenzenesulfonic acid and salts thereof. As still other compounds can be used, the compounds applicable to the invention are not limited to those mentioned here.

Dissociable group-containing polyurethanes can have any of the following dissociable groups; anionic ones such as carboxyl, sulfonic acid, sulfuric acid monoester, —OPO(OH)₂, sulfinic acid and their salts (with alkali metals such as Na and K, or with ammnonium compounds such as ammnonia, dimethylamine, ethanolamine, diethanolamine, triethanolamine and trimethylamine), and cationic ones such as primary, secondary and tertiary amines and quaternary ammonium salts. Among them, anionic groups are particularly preferred, in which carboxyl group is more preferred.

Polyesters can be prepared basically by the polycondensation of a diol and a dicarboxylic acid.

Specific examples of the dicarboxylic acid include, oxalic, malonic, succinic, glutaric, dimethylmalonic, adipic, pimelic, α,α-dimethylsuccinic, acetonedicarboxylic, sebacic, 1,9-nonanedicarboxylic, fumaric, maleic, itaconic, citraconic, phthalic, isophthalic, terephthalic, 2-butylterephthalic, tetrachloroterephthalic, acetylenedicarboxylic, poly(ethylene terephthalate) dicarboxylic, 1,2-cycylohexanedicarboxylic, 1,4-cyclohexanedicarboxylic, ω-poly (ethylene oxide) dicarboxylic or p-xylylenedicarboxylic acid.

When used in the polycondensation reaction with a diol compound, these compounds may either take the form of alkyl ester (e. g. dimethyl ester), the acid chloride of the dicarboxylic acid or the form of acid anhydride exemplified by maleic, succinic or phthalic anhydride.

Dissociable group-containing polyesters can be prepared by using a dicarboxylic acid compound having a dissociable anionic group other than carboxylic acid such as sulfonic acid, sulfuric acid monoester, —OPO(OH)₂, sulfinic acid and their salts (with alkali metals such as Na and K, or with ammnonium compounds such as ammnonia, dimethylamine, ethanolamine, diethanolamine, triethanolamine and trimethylamine), or a dissociable cationic group such as tertiary amine and its salts (with an organic acid such as acetic, propionic or methanesulfonic) and quaternary ammonium salts. Particularly preferable dissociable groups other than carboxylic are anionic, sulfonic acid group being more preferred.

Specific examples of such a dicarboxylic acid as having a sulfonic acid group as the starting diol material described above include sulfophthalic acids such as 3-sulfophthalic, 4-sulfophthalic, 4-sulfoisophthalic, 5-sulfoisophthalic or 2-sulfoterephthalic acid, sulfosuccinic acid, sulfonaphthalenedicarboxylic acids such as 4-sulfo-1,8-naphthalenedicarboxylic or 7-sulfo-1,5-naphthalenedicarboxylic acid, 3,5-di(2-hydroxy)ethyloxycarbonylbenzenesulfonic acid and the salts thereof.

Suitable diol compounds are common to those mentioned in the above description for the diols for polyurethanes.

The polyesters described above can be synthesized typically by the condensation reaction between the diol compound and the dicarboxylic acid both of which have been cited above whereby instead of the dicarboxylic acid, its derivative may be used, too. Further, the polyesters suited for the invention can be obtained by condensing a hydroxycarboxylic acid such as, for example, 12-hydoxystearic acid, or by the ring-opening polymerization with a cyclic ether and a lactone as is described in detail in Koza, Jugo Han-no Ron (Series of Lectures on Polymerization Reaction) 6, Kaikan Jugo (Ring-opening polymerization) (I) written by Takeo Saegusa and published by Kagaku-dojin Publishing Co., Ltd. in 1971.

The above mentioned polyamides can be prepared by the polycondensation of a diamine compound with a dicarboxylic acid compound, by the polycondensation of an aminocarboxylic acid compound, or by the ring-opening polymerization of a lactum.

Suitable diamine compounds include ethylenediamine, 1,3-propanediamine, 1,2-propanediamine, hexamethylenediamine, octamethylenediamine, o-phenylenediamine, m-phenylenediamine, p-phenylenediamine, piperazine, 2,5-dimethylpiperazine, 4,4′-diaminodiphenyl ether, 3,3′-diaminodiphenylsulfone and xylylenediamine. And as aminocarboxylic acid, use is made of glycine, alanine, phenylalanine, ω-aminohexanoic acid, ω-aminodecanoic acid, ω-aminoundecanoic acid and anthranillic acid. Monomers used for the ring-opening polymerization include ε-caprolactum, azetidinone and pyrrolidone.

Suitable dicarboxylic acid compounds are common to those suitably used for the synthesis of the polyesters described above.

The polyureas cited above can be prepared basically by the polyaddition of a diamine with a diisocyanate, or by the deammoium reaction between a diamine and urea. The diamine as the starting material is common to those mentioned in the above description on the polyamides while suitable diisocyanates are common to those suitably used for the synthesis of the polyesters described above.

The afore-mentioned polycarbonates can be obtained basically by reacting a diol compound with phosgene or a carbonate ester derivative such as, for example, the aromatic ester of diphenylcarbonate whereby the diols as the starting material are common to those mentioned above in the description on the synthesis of polyurethanes.

The afore-mentioned dissociable group can be introduced in each polymer described heretofore by a variety of methods. For example, a dissociable group can be introduced in the polymer principal chain of a polyurethane as a substituent by using a diol having a dissociable group for condensation. In the case of polyester as water-insoluble polymer, a carboxylic acid group can be left as an unreacted terminating group of the polymer chain. Alternatively, reactive groups such as hydroxy or amino present in the polymer chain resulting from polymerization reaction may be subjected to a further reaction with an acid anhydride such as maleic anhydride that can provide the polymer with a dissociable group.

The dissociable group-containing polymers, both of the vinyl ones and condensed ones, set forth heretofore may be used individually or in combination of two or more kinds at arbitrary mixing ratios with various purposes of, for example, the adjustment of glass transition temperature (Tg) or the modification of the solubility properties, the compatibility with dyes and the dispersion stability.

Among the dissociable group-containing polymers described heretofore, those having either a carboxyl or a sulfonic acid group as the dissociable group are preferred. Particularly preferable polymers have a carboxyl group.

With too small or too large contents of such a dissociable group, the self-emulsifying property of the dissociable group-containing polymer deteriorates, thus failing to sufficiently stabilize the dispersion of particulate dyes. A preferable range of the content of the dissociable group in the dissociable group-containing polymer is from 0.1 to 3.0 mmol/g, a more preferable range being 0.2 to 2.0 mmol/g.

As the anionic dissociable groups to be contained in the dissociable group-containing polymers, alkali metals (e. g., Na and K) or ammonium salts may be used. The tertiary amine group as the cationic dissociable group may be in the form of the salts of an organic (e. g., acetic, propionic or methanesulfonic) acid or those of an inorganic (e. g., hydrochloric or sulfuric) acid.

Among the dissociable group-containing polymers described heretofore, vinyl polymers, polyurethanes and polyesters and in particular vinyl polymers are preferred from the viewpoint of providing an excellent dispersion stability as well as the ease with which the dissociable group can be introduced in the molecular structure.

Some specific examples [(PP-1) to (PP-54)] of the dissociable group-containing polymer described heretofore are listed in Tables 2 and 3, but self-evidently the invention is not limited by these examples at all. In the tables, the ratios in the parentheses mean mass ratio.

TABLE 2

| PP-1) | tert-butyl methacrylamide/methyl methacrylate/ |
|---|---|
| | acrylic acid copolymer (60:30:10) |
| PP-2) | n-butyl acrylate/acrylic acid copolymer (95:5) |
| PP-3) | methyl methacrylate/isobutyl methacrylate/acrylic |
| | acid copolymer (60:30:10) |
| PP-4) | sec-butyl acrylate/acrylic acid copolymer (90:10) |
| PP-5) | ethyl acrylate/acrylic acid copolymer (95:5) |
| PP-6) | isopropyl acrylate/acrylic acid copolymer (90:10) |
| PP-7) | n-butyl acrylate/2-hydroxyethyl methacrylate/ |
| | acrylic acid copolymer (85:5:10) |
| PP-8) | isobutyl methacrylate/tetrahydrofurfryl acrylate/ |
| | acrylic acid copolymer (60:30:10) |
| PP-9) | n-butyl methacrylate/1H, 1H, 2H, 2H-perfluorodecyl |
| | acrylate/acrylic acid copolymer (75:20:5) |
| PP-10) | methyl methacrylate/n-butyl acrylate/acrylic acid |
| | copolymer (47.5:47.5:5) |
| PP-11) | 2-ethylhexyl methacrylate/methyl acrylate/acrylic |
| | acid copolymer (40:55:5) |
| PP-12) | 3-methoxybutyl methacrylate/styrene/acrylic acid |
| | copolymer (35:50:15) |
| PP-13) | cyclohexyl methacrylate/allyl methacrylate/acrylic |
| | acid copolymer (70:20:10) |
| PP-14) | isopropyl methacrylate/2-butoxyethyl methacrylate/ |
| | acrylic acid copolymer (80:15:5) |
| PP-15) | ethyl acrylate/phenyl methacrylate/acrylic acid |
| | copolymer (82:15:3) |
| PP-16) | methyl methacrylate/2-ethylhexyl acrylate/acrylic |
| | acid copolymer (47.5:47.5:5) |
| PP-17) | isobutyl methacrylate/methacrylic acid ester of |
| | poly(ethylene glycol) monomethyl ether (number of |
| | ethylene oxy chain repeating units = 23)/acrylic acid |
| | copolymer (70:25:5) |
| PP-18) | isobutyl methacrylate/dipropylene glycol |
| | monomethacrylate/acrylic acid copolymer (85:10:5) |
| PP-19) | isobutyl methacrylate/methacrylic acid ester of |
| | poly(ethylene glycol) monomethyl ether (number of |
| | ethylene oxy chain repeating units = 9)/acrylic acid |
| | copolymer (85:10:5) |
| PP-20) | isobutyl acrylate/methoxystyrene/acrylic acid |
| | copolymer (75:15:10) |
| PP-21) | tert-butyl acrylate/methacrylic acid copolymer |
| | (88:12) |
| PP-22) | hexyl acrylate/styrene/methacrylic acid copolymer |
| | (80:10:10) |
| PP-23) | 2,2,2-tetrafluoroethyl methacrylate/methyl |
| | methacrylate/methacrylic acid copolymer (35:60:5) |
| PP-24) | ethyl methacrylate/methacrylic acid copolymer (95:5) |
| PP-25) | ethyl methacrylate/2-methoxyethyl methacrylate/ |
| | methacrylic acid copolymer (70:15:15) |
| PP-26) | n-butyl methacrylate/methacrylic acid copolymer |
| | (95:5) |
| PP-27) | vinyl acetal/methacrylic acid copolymer (85:15) |
| PP-28) | n-butyl methacrylate/acrylamide/methacrylic acid |
| | copolymer (80:15:5) |
| PP-29) | tert-octylacrylamide/propyl methacrylate/ |
| | methacrylic acid copolymer (20:65:15) |
| PP-30) | n-butyl methacrylate/butoxymethylacrylamide/ |
| | methacrylic acid copolymer (80:5:15) |
| PP-31) | n-butyl methacrylate/ |
| | diphenyl-2-methacryloyloxyethyl phosphate/ |
| | methacrylic acid copolymer (50:40:10) |
| PP-32) | isobutyl methacrylate/dimethylacrylamide/ |
| | methacrylic acid copolymer (80:15:5) |
| PP-33) | n-butyl methacrylate/phenylacrylamide/methacrylic |
| | acid copolymer (70:15:15) |
| PP-34) | n-butyl methacrylate/phenylacrylamide/methacrylic |
| | acid copolymer (70:15:15) |
| PP-35) | isobutyl methacrylate/2-(2-methoxyethoxy) ethyl |
| | methacrylate/methacrylic acid copolymer (50:35:15) |
| PP-36) | ethyl methacrylate/2-carboxyethyl methacrylate |
| | copolymer (90:10) |
| PP-37) | n-butyl methacrylate/styrenesulfonic acid copolymer |
| | (90:10) |
| PP-38) | ethyl methacrylate/styrenesulfonic acid copolymer |
| | (90:10) |
| PP-39) | n-butyl acrylate/styrene/styrenesulfonic acid |
| | copolymer (60:35:5) |
| PP-40) | n-butyl acrylate/1H, 1H, 2H, 2H-perfluorodecyl |
| | methacrylate/styrenesulfonic acid copolymer |
| | (80:10:10) |
| PP-41) | n-butyl methacrylate/ |
| | 2-acrylamide-2-methylethanesulfonic acid copolymer |
| | (90:10) |
| PP-42) | isobutyl acrylate/n-butyl methacrylate/ |
| | 2-acrylamide-2-methylethanesulfonic acid copolymer |
| | (70:20:10) |

TABLE 3

| PP-43) | n-butyl methacrylate/ |
|---|---|
| | 2-acrylamide-2-methylpropanesulfonic acid copolymer |
| | (90:10) |
| PP-44) | ethyl methacrylate/ |
| | 2-acrylamide-2-methylpropanesulfonic acid copolymer |
| | (90:10) |
| PP-45) | ethyl acrylate/tert-butyl methacrylate/ |
| | 2-acrylamide-2-methylpropanesulfonic acid copolymer |
| | (60:35:5) |
| PP-46) | tert-butyl acrylate/tetrahydrofurfuryl acrylate/ |
| | 2-methylpropanesulfonic acid copolymer (50:40:10) |
| PP-47) | tert-butyl acrylate/methacrylic acid ester of |
| | poly(ethylene glycol) monomethyl ether (number of |
| | ethylene oxy chain repeating units = 23)/ |
| | 2-acrylamide-2-methylpropanesulfonic acid copolymer |
| | (70:27:3) |
| PP-48) | isobutyl acrylate/N-vinylpyrrolidone/ |
| | 2-acrylamide-2-methylpropanesulfonic acid copolymer |
| | (65:30:5) |
| PP-49) | isobutyl methacrylate/ |
| | 2-acrylamide-2-methylpropanesulfonic acid copolymer |
| | (88:12) |
| PP-50) | n-butyl methacrylate/ |
| | 2-methacrylamide-2-methylpropanesulfonic acid |
| | copolymer (90:10) |
| PP-51) | n-butyl acrylate/tert-butyl methacrylate/ |
| | vinylsulfonic acid copolymer (60:30:10) |
| PP-52) | ethyl acrylate/tert-butyl methacrylate/ |
| | vinylsulfonic acid copolymer (60:30:10) |
| PP-53) | ethyl methacrylate/ |
| | 2-acrylamide-2-methylbutanesulfonic acid copolymer |
| | (90:10) |
| PP-54) | n-butyl methacrylate/ |
| | 2-acrylamide-2-methylbutanesulfonic acid copolymer |
| | (88:12) |

Some specific examples [(PP-55) to (PP-74)] of the dissociable group-containing condensation polymer described heretofore are listed in Tables 4, but self-evidently the invention is not limited by these examples at all. The acid group of each polymer is expressed as undissociated form. As for the polymers such as polyesters and polyamides synthesized by condensation reactions, the compositions are expressed in terms of dicarboxylic acid, diol, diamine, hydroxycarboxylic acid or aminocarboxylic acid, indifferent to the actually used raw materials. The ratios in the parentheses mean the mole % of each ingredient.

TABLE 4

| PP-55) | 4,4′-diphenylmethane diisocyanate/hexamethylene |
|---|---|
| | diisocyanate/tetraethylene glycol/ethylene glycol/ |
| | 2,2-bis (hydroxymethyl)propionic acid |
| | (40/10/20/20/10) |
| PP-56) | 4,4′-diphenylmethane diisocyanate/hexamethylene |
| | diisocyanate/butanediol/poly(ethylene glycol) (Mw = |
| | 400)/2,2-bis (hydroxymethyl) propionic acid |
| | (40/10/20/10/20) |
| PP-57) | 1,5-naphthylene diisocyanate/butanediol/ |
| | 4,4′-dihydroxy-diphenyl-2,2′-propane/ |
| | poly(propylene glycol) (Mw = 400)/ |
| | 2,2-bis(hydroxymethyl)propionic acid (50/20/5/10/15) |
| PP-58) | 1,5-naphthylene diisocyanate/hexamethylene |
| | diisocyanate/2,2-bis (hydroxymethyl)butanoic acid/ |
| | poly(butylene oxide) (Mw = 500) (35/15/25/25) |
| PP-59) | isophorone diisocyanate/diethylene glycol/neopentyl |
| | glycol/2,2-bis (hydroxymethyl)propionic acid |
| | (50/20/20/10) |
| PP-60) | toluene diisocyanate/2,2-bis (hydroxymethyl)butanoic |
| | acid/poly(ethylene glycol) (Mw = 1000)/cyclohexane |
| | dimethanol (50/10/10/30) |
| PP-61) | diphenylmethane diisocyanate/hexamethylene |
| | diisocyanate/tetraethylene glycol/butanediol/ |
| | 3,5-di(2-hydroxy)ethyloxycarbonylbenzenesulfonic |
| | acid (40/10/10/33/7) |
| PP-62) | diphenylmethane diisocyanate/hexamethylene |
| | diisocyanate/butanediol/ethylene glycol/ |
| | 2,2-bis (hydroxymethyl)butanoic acid/ |
| | 3,5-di(2-hydroxy)ethyloxycarbonylbenzenesulfonic |
| | acid (40/10/20/15/10/5) |
| PP-63) | terephthalic acid/isophthalic |
| | acid/5-sulfoisophthalic acid/ethylene glycol/ |
| | neopentyl glycol (24/24/2/25/25) |
| PP-64) | terephthalic acid/isophthalic acid/ |
| | 5-sulfoisophthalic acid/cyclohexanedimethanol/ |
| | 1,4-butanediol/ethylene glycol (22/22/6/25/15/10) |
| PP-65) | isophthalic acid/5-sulfoisophthalic acid/ |
| | cyclohexanedimethanol/ethylene glycol (40/10/40/10) |
| PP-66) | cyclohexanedicarboxylic acid/isophthalic acid/ |
| | 3,5-di(2-hydroxy)ethyloxycarbonylbenzenesulfonic |
| | acid/cyclohexanedimethanol/ethylene glycol |
| | (30/20/5/25/20) |
| PP-67) | 11-aminoundecanoic acid (100) |
| PP-68) | 12-aminododecanoic acid (100) |
| PP-69) | reaction product of poly(12-aminododecanoic acid) with |
| | maleic anhydride (100) |
| PP-70) | 11-aminoundecanoic acid/7-aminoheptanoic acid (50/50) |
| PP-71) | hexamethylenediamine/adipic acid (50/50) |
| PP-72) | N,N-dimethylethylenediamine/adipic acid/ |
| | cyclohexanedicarboxylic acid (50/20/30) |
| PP-73) | toluene diisocyanate/hexamethylenediamine/ |
| | 2,2-bis (hydroxymethyl)propionic acid (50/40/10) |
| PP-74) | 11-aminoundecanoic acid/hexamethylenediamine/urea |
| | (33/33/33) |

As for the synthesis of dissociable group-containing condensation polymers, various processes described in the following literatures and well known in the art can be used.

Kobunshi Jikkengaku (Polymer Experiment) (Vol. 5), Jushukugo to Jufuka (Polycondensation and Polyaddition), edited by S. Kanbara, published by Kyoritsu Shuppan Co., Ltd. in 1980, Poriesuteru Jushi Handobukku (Polyester Resin Handbook), authored by E. Takiyama, published by Nikkan Kogyo Shinbunsha in 1988, Poriuretan Jusyi Handobukku (Polyurethane Resin Handbook, edited by K. Iwata and published by Nikkan Kogyo Shinbunsha in 1987, Koubunshi Gosei no Jikken-ho (Experimental Methods for Polymer Synthesis), authored by T. Ohtsu and M. Kinoshita, published by Kagaku-Dojin Publishing Co., Ltd. in 1972, JP-B-33-1141, JP-B-37-7641, JP-B-39-5989, JP-B-40-27349, JP-B-42-5118, JP-B-42-24194, JP-B-45-10957, JP-B-48-25435, JP-B-49-36942, and JP-B-52-81344, and JP-A-56-88454 and JP-A-6-340835.

To prevent inkjet head choking and secure the expected effects on color hue, color reproduction capability and bronze suppression, the molecular weight (Mw) of the dissociable group-containing polymer of the invention preferably lies in the range of from 1,000 to 200,000, and more preferably from 2,000 to 50,000. And, the average diameter of the polymer particles is preferably from 10 to 400 nm, and more preferably from 20 to 200 nm. Further, the solid content of the water-dispersible polymer particles is preferably one to ten times, and more preferably two to six times that of the J-aggregate of a dye. The polymer particles may consist of a single component or of two or more components mixed together.

In preferably practicing the invention, the J-aggregate of a dye cited previously is dispersed first in an aqueous medium, to which, then, the aqueous dispersion of water-dispersible polymer particles as well as other additives is added to prepare an ink.

The ink for inkjet recording of the invention should preferably contain 0.2 to 10 parts by weight of the J-aggregate of a dye per 100 parts by weight of the ink. And, together with dyes capable of J-aggregation formation, other types of dyes may be used in the inkjet ink of the invention. When two or more kinds of dyes are used, the total amount of the dyes should lie in the range cited above.

The inkjet ink used in the invention can contain various additives such as a (moistening) agent to suppress ink drying for the purpose of head choking prevention, a penetration promoter that accelerates ink penetration into paper, a UV absorber, an antioxidant, a viscosity controlling agent, a surface tension controlling agent, a dispersant, a dispersion stabilizer, an antiseptic, an anticorrosive, a pH controlling agent, an antifoaming agent and a chelating agent, each being used at an appropriate content level.

As the (moistening) agent to suppress ink drying, one can preferably use a water-miscible organic solvent having a lower vapor pressure than water. Specific examples include polyhydric alcohols such as ethylene glycol, propylene glycol, diethylene glycol, poly(ethylene glycol), thiodiglycol, dithiodiglycol, 2-methyl-1,3-propanediol, 1,2,6-hexanetriol, acetylene glycol derivatives, glycerin and trimethylolpropane, loweralkyl ethers of polyhydric alcohols such as ethylene glycol monomethyl (or ethyl) ether, diethylene glycol monomethyl (or ethyl) ether and triethylene glycol monoethyl (or butyl) ether, heterocyclic compounds such as 2-pyrrolidone, N-methyl-2-pyrrolidone, 1,3-dimethyl-2-imidazolidinone and N-ethylmorpholine, sulfur-containing compounds such as sulfolane, dimethylsulfoxide and 3-sulfolene, polyfunctional compounds such as diacetone alcohol and diethanolamine. Among them, polyhydric alcohols such as glycerin anddiethylene glycol are more preferred. These compounds may be used individually or in combination of two or more of them. A preferable content range of such an agent to suppress ink drying is from 10 to 50% by weight of ink.

Penetration promoting agents used in the invention preferably comprise alcohols such as ethanol, isopropanol, butanol, di (or tri) ethylene glycol monobutyl ether or 1,2-hexanediol, sodium laurylsulfate, sodium oleate or nonionic surfactants. Such an agent, which exerts a sufficient effect when present in 10 to 30% by weight of ink, should be used within the range where too much spread or print-through of recorded images does not occur.

UV absorbers used in the invention to improve the permanence of recorded images include the benzotriazole compounds described in JP-A-58-185677, JP-A-61-190537, JP-A-2-782, JP-A-5-197075 and JP-A-9-34057, the benzophenone compounds described in JP-A-46-2784 and JP-A-5-194483 and U.S. Pat. No. 3,214,463, the cinnamic acid derivatives described in JP-B-48-30492, JP-B-56-21141 and JP-A-10-88106, the triazine compounds described in JP-A-4-298503, JP-A-8-53427, JP-A-8-239368 and JP-A-10-182621 and JP-W-8-501291 (The term “JP-W” as used herein means an “international patent application published in the Japanese national proceeding”), and fluorescent whitening agents which fluoresce with the absorption of UV light, represented by stylbene and benzoxazole compounds or those disclosed in Research Disclosure No.24239.

The antioxidant applicable to the invention to improve the permanence of recorded images includes color fading inhibitors comprising various organic compounds or metal complexes. Such organic color fading inhibitors include hydroquinones, alkoxyphenols, dialkoxyphenols, phenols, anilines, amines, indan and chroman as well as derivatives thereof, alkoxyanilines and heterocyclic compounds while suitable metal complexes include nickel and zinc complexes. More specifically, the compounds described in the patents cited in items I to J of VII of Research Disclosure No. 17643, Research Disclosure No. 15162 and the left column, p. 650 of Research Disclosure No. 18716, p.527 of Research Disclosure No. 36544, p.872 of Research Disclosure No. 30710 and Research Disclosure No. 15162, or those represented by the general formulae shown in pp. 127 to 137 of JP-A-62-215272, and those cited as compound examples in the same specification can be used.

The antiseptics applicable to the invention include sodium dehydroacetate, sodium benzoate, sodium pyridinethione-1-oxide, ethyl p-hydroxybenzoate, 1,2-benzisothiazoline-3-one and the salts thereof. The antiseptic should be used in 0.02 to 1.00% by weight of ink.

In the invention, the pH controlling agent, which controls the pH of the dispersion containing the particulate colorant and imparts dispersion stability to the ink, should be used in such a manner as to adjust the pH between 4.5 and 10.0 and more preferably between 6 and 10.0. As such a pH controlling agent, organic bases or inorganic alkaline compounds, organic and inorganic acids can be used, the former two groups being basic while the latter two are acid.

Suitable organic bases include triethanolamine, diethanolamine, N-methyldiethanolamine and dimethylethanolamine. Suitable inorganic alkaline compounds include the hydroxides of alkali metals such as NaOH, LiOH and KOH, carbonate salts such as NaCO₃ and NaHCO₃, and ammonia.

Suitable organic acids include acetic, propionic, trifluoroacetic and alkylsulfonic, and suitable inorganic acids are hydrochloric, sulfuric and phosphoric.

As the surface tension controlling agent used in the invention, nonionic, cationic or anionic surfactants are included. Examples of the anionic surfactant include fatty acid salts, alkylsulfuric acid salts, alkylbenzenesulfonic acid salts, alkylnaphthalenesulfonic acid salts, dialkylsulfosuccinic acid salts, salts of alkylphosphoric acid esters, naphthalenesulfonic acid-formaldehyde condensates and salts of poly(oxyethylene)alkyl sulfate. Examples of the nonionic surfactant include polyoxyethylene alkyl ethers, polyoxyethylene alkylallyl ethers, polyoxyethylene fatty acid esters, sorbitan fatty acid esters, polyoxyethylene sorbitan fatty acid esters, polyoxyethylenealkylamines, glycerin fatty acid esters and oxyethylene-oxypropylene block copolymers. Further, SURFYNOLS, which are acetylene-based polyoxyethylene oxide surfactants made by Air Products & Chemicals Co., Ltd., are also preferably used. Amine oxide type amphoteric surfactants such as N,N-dimethyl-N-alkylamine oxide are also preferably used. The surfactants described in pp. 37 to 38 of JP-A-59-157636 and Research Disclosure No. 308119 (1989) can further be used.

The surface tension of the ink of the invention should be 20 to 60 mN/m with or without such a surface tension controlling agent. A more preferable range is 25 to 45 mN/m.

As the ink of the invention preferably has a viscosity not higher than 30 mPa·s, and more preferably not higher than 20 mPa·s, a viscosity controlling agent may sometimes be used. Suitable viscosity controlling agents include, for example, water-soluble polymers such as cellulose derivatives and poly (vinyl alcohol), and nonionic surfactants. More detailed descriptions are found in Chapter 9 of Nendo Chosei Gijutsu (Viscosity Controlling Techniques), published by Gijutsu Joho Kyokai (Technical Information Association) in 1999, and pp. 162 to 174 of Inku-jetto Purinter Yoh Kemikarusu (Chemicals for Inkjet Printer) (revised and supplemented in 1998)—Zairyo no Kaihatsu Doko-Tenbo Chosa (Trend Survey: Material Development and Outlook), published by CMC Co., Ltd. in 1997.

In practicing the invention, various surfactants including cationic, anionic and nonionic ones cited above can be used as dispersant or as dispersion stabilizer. Further, fluorine- or silicone-containing compounds may also be used as antifoaming agents, and chelating agents represented by EDTA may be used if needed.

The inks for inkjet recording of the invention can record not only monochromatic but also full-color images. For full-color image formation, magenta, cyan and yellow colored inks are used. Further, to control color hue and gradation, a black colored ink is also used. When at least one of these inks is prepared according to the invention, full-color images with vivid colors can be recorded. Moreover, when all the inks used for full-color recording are prepared according to the invention, full-color images with superior color hues can be recorded.

The image-receiving materials for the inkjet recording using an ink prepared according to the invention include plain paper, coated paper and plastic film. By using a coated paper as image-receiving material, an improved image quality as well as an improved image permanence is achieved.

The ink of the invention can be used for image recording on various recording materials such as plain paper, resin coated paper, dedicated inkjet recording paper which is disclosed in, for example, JP-A-8-169172, JP-A-8-27693, JP-A-2-276670, JP-A-7-276789, JP-A-9-323475, JP-A-62-238783, JP-A-10-153989, JP-A-10-217473, JP-A-10-235995, JP-A-10-337947, JP-A-10-217597 and JP-A-10-337947, films, paper commonly used for inkjet and electrophotography, cloth, glass, metal and ceramic.

In the following, image-receiving paper and film used for making inkjet prints with use of the inks of the invention will be described. The substrate for such image-receiving paper or film is made of chemical pulp such as LBKP or NBKP, mechanical pulp such as GP, PGW, RMP, TMP, CTMP, CMP or CGP, or regenerated pulp such as DIP, to which, if needed, are added various additives well known in the art including pigment, binder, sizing agent, fixing agent, cationic agent and paper strengthening agent. The resulting mixture is processed to a sheet-formed product with a variety of paper machines such as Fourdrinier or cylinder type. In addition to the substrates thus prepared, synthetic papers and plastic films can also be used. The thickness of such a substrate is preferably in the range of 10 to 250 mm while the grammage should preferably be from 10 to 250 g/m². An image-receiving material can be prepared by providing such a substrate with an image-receiving layer and a back coating directly or after a size press or an anchor coating is provided comprising starch or poly(vinyl alcohol). The substrate may be subjected to a smoothing treatment by the use of various calendering machines such as machine calender, TG calender or soft calender. Favorable substrates for the invention include those comprising a base paper or film laminated at its both surfaces with a thin layer of polymer such as polyethylene, polystyrene, poly(ethylene terephthalate), polybutene or copolymers made of the monomers composing these polymers. It is desirable to incorporate in the laminated polymer a white pigment such as TiO₂ or ZnO or a coloring agent such as cobalt blue, ultramarine or neodymium oxide.

The image-receiving layer provided on the substrate contains a pigment and a hydrophilic binder. As such pigments, white ones are preferred. Such white pigments include inorganic white ones such as calcium carbonate, kaolin, talc, clay, diatomaceous earth, synthetic amorphous silica, aluminum silicate, magnesium silicate, calcium silicate, aluminum hydroxide, alumina, lithopon, zeolite, barium sulfate, calcium sulfate, titanium dioxide, zinc sulfide and zinc carbonate, and organic ones such as styrene-based and acrylate-based pigments, urea or melamine resin particles. Among the white pigments cited above to be included in the image-receiving layer, highly porous inorganic ones are preferred, and synthetic amorphous silica is particularly preferred. As synthetic amorphous silica, both of anhydrous silicic acid obtained by dry processes and hydrous silicic acid obtained by wet processes can be used, the latter being more preferred. Two or more kinds of these pigments may be used together.

The hydrophilic binder to be contained in the image-receiving layer includes water-soluble polymers such as poly(vinyl alcohol), silanol-modified poly(vinyl alcohol), starch, cationated starch, casein, gelatin, carboxymethyl cellulose, hydroxyethyl cellulose, polyvinylpyrrolidone, poly(alkylene oxide), poly(alkylene oxide) derivatives and water dispersible polymers such as styrene-butadiene latex and acrylic emulsion. The hydrophilic binder may comprise a single or plural polymers selected from those mentioned hereinabove. In the invention, poly(vinyl alcohol) and silanol-modified poly(vinyl alcohol) are suited from the viewpoints of the adhesion to pigments and the difficulty with which the image-receiving layer is detached.

The image-receiving layer can contain, in addition to the pigment and the aqueous binding agent (binder), various additives such as water-resistance imparting agent, light fastness improving agent, surfactant and crosslinking agent.

As the water-resistance imparting agent, which is effective to provide recorded images with water-resistance, cationic resins are specifically suited. Such cationic resins include polyamide polyamineepichlorohydrin, polyethyleneimine, polyaminesulfone, polymerized dimethyldiallylammonium chloride and cationicpolyacrylamide. Colloidal silica can also be used as water-resistance imparting agent. Among those cationic resins, polyamidepolyamineepichlorohydrin is particularly preferred. The content of the cationic resin is 1 to 15% by weight, and preferably 3 to 10% by weight based on the total solid quantity of the image-receiving layer.

As the light-fastness improving agent, zinc sulfate, zinc oxide, hindered amine-based antioxydants, benzotriazole type UV absorbers exemplified by benzophenone are used. Among them, zinc sulfate is specifically suited.

Surfactants act as a coating aid, a layer detachment suppresser, a slipping property improving agent or an anti-static agent. As for the surfactants used for such functions, related descriptions are found in JP-A-62-173463 and JP-A-62-183457.

Instead of surfactants, organic fluoro compounds may be used, which is desirably hydrophobic. Examples of preferable organic fluoro compounds include fluorine-containing surfactants, oily and solid fluoro compounds each exemplified by fluorinated oils and tetrafluoroethylene polymers. Organic fluoro compounds are described in the 8th to 17th columns of JP-B-57-9053 and JP-A-61-20994 and JP-A-62-135826.

The materials described in p. 222 of JP-A-1-161236 can be used as crosslinking agent.

Still other additives to be incorporated in the image-receiving layer include a pigment dispersant, a viscosity raising agent, an antifoaming agent, a dye, a fluorescent whitening agent, an antiseptic, a pH controlling agent, a matting agent and a crosslinking agent. The image-receiving layer may comprise single or double layers.

The image recording papers and films can have a backcoating, which comprise a white pigment, an aqueous binding agent (aqueous binder) and other ingredients. The white pigments to be incorporated in the backcoating include, for example, inorganic white pigments such as precipitated calcium carbonate light, calciumcarbonate heavy, kaolin, talc, calcium sulfate, barium sulfate, titanium dioxide, zinc oxide, zinc sulfide, zinc carbonate, satin white, aluminum silicate, diatomaceous earth, calcium carbonate, magnesium silicate, synthetic amorphous silica, colloidal silica, colloidal alumina, pseudo boehmite, aluminum hydroxide, alumina, lithopone, zeolite, hydrated halloysite, magnesium carbonate and magnesium hydroxide, organic pigments such as styrene-based and acrylic-based plastic pigments, polyethylene, microcapsules, urea and melamine resins.

The aqueous binders to be incorporated in the back coating include water-soluble polymers such as styrene/maelic acid salt copolymer, styrene/acrylicacidcopolymer, poly (vinyl alcohol), silanol-modified poly(vinyl alcohol), starch, cationated starch, casein, gelatin, carboxymethyl cellulose, hydroethyl cellulose and polyvinylpyrrolidone and water-dispersible polymers such as styrene-butadiene latex and acrylic emulsion. Other ingredients to be incorporated in the back coating include an antifoaming agent, a foam suppressing agent, a dye, a fluorescent whitening agent, an antiseptic and a water-resistance imparting agent.

The coatings composing inkjet recording papers and films (including the back coating) can contain a polymer latex in order to improve the physical properties of the coating. Typical items of such improvement include dimensional stability, anti-curling, adhesive sticking prevention and cracking prevention. Polymer latices are described in JP-A-62-245258, JP-A-62-1316648 and JP-A-62-110066. By adding a polymer latex with a glass transition temperature as low as 40° C. or lower, the coating is prevented from cracking and curling. Alternatively, one can prevent curling by incorporating a polymer latex with a high transition temperature.

The inkjet ink of the invention is applicable to any inkjet recording method well known in the art without any limitation, such methods including, for example, the charge controlling method wherein ink is ejected by electrostatic attractive forces, the drop-on-demand (pressure pulse) method based on oscillating pressure caused by piezo elements, the acoustic method wherein an acoustic beam converted from electric signals is irradiated onto ink, which is ejected by the radiation pressure, and the thermal (bubblejet) method based on the pressure caused by air bubbles that are formed by heat application to the ink.

The inkjet recording methods to which the invention is applied includes one in which a large number of minute volume droplets comprising low colorant concentration inks called ‘photo-ink’ are ejected, one in which the image quality of recorded images is improved by using plural kinds of inks different in colorant concentration but having substantially the same hue, and one using a clear colorless ink.

### EXAMPLE

In the following, the invention will be explained more in detail by describing some examples, but is not limited to the following examples at all.

### Example 1

The following ingredients were mixed with a sand grinder mill charged with 0.3 mm diameter zirconia beads and rotating at 1200 rpm for 3 hours to give a dispersion of a J-aggregate of a dye.

| | | |
|---|---|---|
| Dye 2-20 | 1.5 | g |
| Sodium p-t-octylphenylpolyoxyethylenesulfonate | 0.6 | g |
| 1N sodium hydroxide | 2.2 | cc |
| Water | 71 | cc |

The particle diameter of the resulting dispersion was measured with a Microtrac UPA 150, a product of Nikkiso Co., Ltd. to give 40 nm in terms of volume-averaged value.

By using the dispersion, an ink for inkjet recording of the following composition (Ink 1) was prepared.

| | |
|---|---|
| The above dispersion | 12.5 g |
| Ethylene glycol | 1.3 g |
| Glycerin | 1.3 g |
| Nipol LX438C* | 1.7 g |
| Water to make in total 25 g | |

*45% Styrene-butadiene aqueous latex with particle diameter of 150 nm, made by Nippon Zeon Co., Ltd.

* 45% Styrene-butadiene aqueous latex with particle diameter of 150 nm, made by Nippon Zeon Co., Ltd.

Image recording was carried out by using Ink 1 in a PM770C inkjet printer, a product of Seiko Epson Co., Ltd. onto a photo-grade glossy paper (Photo Glossy Paper EX, an inkjet paper made by Fuji Photo Film Co., Ltd.).

A very vivid magenta image was obtained with a λmax at 550 nm and an absorption half-width of 60 nm.

The dye 2-20 used in the ink was dissolved in DMF; the absorption spectrum of the resulting solution had a λmax at 490 nm. Accordingly, the recorded image with the above-described ink is made of a J-aggregate showing an absorption shift of 60 nm.

### Example 2

In a 200 ml three-neck flask equipped with a stirrer and a reflux cooling tube, 3.0 g of a water-insoluble, dissociable group-containing polymer (PP-10) was dissolved in 17 gisopropyl alcohol. Then, 0.17 g sodium bicarbonate and 1 g distilled water were added and the content was heated to 80° C. under stirring.

To the mixture, 50 ml distilled water was added dropwise under stirring at the rate of 1 ml/min. After the termination of the addition, the resulting polymer dispersion was condensed at 40° C. under a reduced pressure, and then filtered through a 225 mesh filter cloth, giving a polymer dispersion (PD-1) with a solid content of 18.0%. The particle diameter of the polymer dispersion proved to be 28.2 nm.

Ink 2 was prepared by repeating the preparation procedures for Ink 1 of Example 1 except that 4 g of the polymer dispersion PD-1 was used instead of 1.7 g Nipol LX438C. Inkjet recording was carried out similarly to Example 1 with the use of Ink 2. The recorded image was also of a vivid magenta color with a λmax at 550 nm and an absorption half-width of 60 nm.

### Comparative Example

The preparation of Ink 1 of Example 1 was repeated except that Nipol LX438C was omitted, and the resulting ink was designated as Ink 3. By using Ink 3, inkjet recording was carried out as in Example 1. The recorded image looked yellowish magenta with a metallic luster of greenish tint.

According to the invention, ink compositions for inkjet recording can be provided which can form images with suppressed coalescence and bronzing of dyes on the image-receiving paper and with a superior color reproducing capability based on desirable hues having sharp absorptions with narrow absorption half-widths.

The entire disclosure of each and every foreign patent application from which the benefit of foreign priority has been claimed in the present application is incorporated herein by reference, as if fully set forth.

What is claimed is:

1. An aqueous ink composition for inkjet recording comprising:
a dye J-aggregate having an average particle size of 2 to 200 nm; and
water-dispersible polymer particles having an average particle size of 10 to 400 nm, wherein the amount of the water-dispersible polymer particles is from one to ten times as much as that of the J-aggregate.

2. An image forming method comprising:
applying an ink composition for inkjet recording comprising a dye J-aggregate having an average particle size of 2 to 200 nm, and water-dispersible polymer particles having an average particle size of 10 to 400 nm, wherein the amount of the water-dispersible polymer particles is from one to ten times as much as that of the J-aggregate,
to an image-receiving material comprising an image-receiving layer and a substrate, wherein the image-receiving layer comprises an inorganic white pigment.

3. An image forming method comprising:
applying an ink composition to an image-receiving material, wherein the ink composition comprises a dye J-aggregate, the image-receiving material comprises an image-receiving layer and a substrate, and the image-receiving layer comprises an inorganic white pigment; and
uniformly applying water-dispersible polymer particles to the image-receiving material simultaneously with or subsequently to the application of the ink composition.

4. An image forming method comprising:
uniformly applying water-dispersible polymer particles to an image-receiving material, the image-receiving material comprising an image-receiving layer and a substrate, wherein the image-receiving layer comprises an inorganic white pigment; and
applying an ink composition comprising a dye J-aggregate to the applied water-dispersible polymer particles during the state that the ink composition can pass through the polymer particles to reach the image-receiving material.

5. The aqueous ink composition according to claim 1, wherein the dye J-aggregate has an average particle size of 5 to 100 nm and the water-dispersible polymer particles have an average particle size of 20 to 200 nm.

6. The aqueous ink composition according to claim 1, which has a pH between 4.5 and 10.0.

7. The aqueous ink composition according to claim 1, which has a surface tension of 20 to 60 mN/m.

8. The aqueous ink composition according to claim 1, which has a viscosity not higher than 30 mPa·s.

9. The aqueous ink composition according to claim 1, wherein the water-dispersible polymer particles are a polymer latex.

10. The aqueous ink composition according to claim 1, wherein the water-dispersible polymer particles are water-insoluble polymers each having at least one dissociable group.

11. The aqueous ink composition according to claim 1, wherein the dye for forming the J-aggregate is selected from the groups represented by the following formulae (1) to (11):
A¹═L¹—(L²═L³)ₘ—Q¹ (1)
A¹═L¹—(L²═L³)ₙ—A² (2)
A³═N—Q¹ (3)
A¹═(L¹—L²)ₚ═B¹ (4)
B¹═L¹—(L²═L³)_{q}—B² (5)
B²—(L¹═L²)ᵣ—Q¹ (6)
(Q¹)₃C⁺. (Z^{y-})_{1/y} (7) 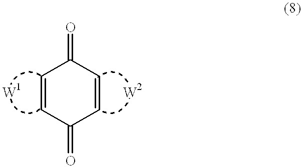
Q¹—N═N—Q² (9) 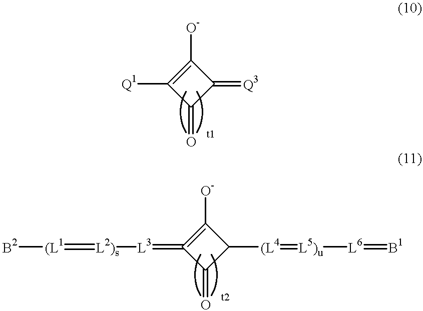
Wherein, A¹ and A² each represents an acid nucleus, A³ represents substituted or unsubstituted phenol, substituted or unsubstituted naphthol, or an acid nucleus, B¹ represents a base nucleus, B² represents the onium form of a base nucleus, Q¹ and Q² each independently represents an aryl group or a heterocyclic group, Q³ represents the onium form of an aryl group or a heterocyclic ring, L¹, L², L³, L⁴, L⁵ and L⁶ each represents a methine group, m, s and u represents an integer of 0, 1 or 2, n and p each represent an integer between 0 and 3, q represents an integer between 0 and 4, r, t₁ and t₂ each represents an integer of 1 or 2, X^{y-} represents an anion, y represents an integer of 1 or 2, and W¹ and W² each independently represents an atomic group needed to complete a five- or six-membered carbocyclic or heterocyclic group.

12. The image forming method according to claim 2, wherein the inorganic white pigment is a synthetic amorphous silica.
